(19) United States
(12) Patent Application Publication
(10) Pub. No.: US 2015/0286975 A1
(43) Pub. Date: Oct. 8, 2015

(54) PROCESS SUPPORT SYSTEM AND METHOD

(71) Applicant: Infineon Technologies AG, Neubiberg (DE)

(72) Inventors: Thomas Berlehner, Regensburg (DE); Sebastian Bernrieder, Regensburg (DE); Thomas Schlegl, Regensburg (DE)

(21) Appl. No.: 14/676,852

(22) Filed: Apr. 2, 2015

(30) Foreign Application Priority Data
Apr. 2, 2014 (DE) 10 2014 104 673.0

(51) Int. Cl. G06Q 10/06

(52) U.S. Cl. CPC G06Q 10/06316

(57) ABSTRACT

A process support system may include a processor for providing a sequence of subprocesses of a process, each being assigned an indication about a desired state, an actuator for providing information, which is presented to a user, about the subprocesses that are to be performed in accordance with the indication, a sensor for detecting a state brought about by the user, the state being linked to the subprocess, a comparator for comparing the detected state with the desired state of the respective subprocess. For the case the subprocess was not performed correctly, the processor provides a correction subprocess, and, for the case the subprocess was performed correctly, the processor provides a subprocess which succeeds the subprocess. The processor assigns to the correction subprocess an indication about a desired correction state, and the comparator compares the detected state with the desired correction state of the respective correction subprocess.

### CROSS-REFERENCE TO RELATED APPLICATION

This application claims priority to German Patent Application Serial No. 10 2014 104 673.0, which was filed Apr. 2, 2014, and is incorporated herein by reference in its entirety.

### TECHNICAL FIELD

Various embodiments may generally relate to a process support system and to a method for supporting a process.

### BACKGROUND

In various production tasks and/or handling tasks, for example during packaging or mounting, manual performance by a user, also designated as worker, may be expedient or necessary. In this case, instructions for work to be carried out by the worker are usually present in the form of, for example written, workplace instructions. The worker can check necessary work steps in the workplace instructions, if appropriate. The worker typically produces a written report, for example by means of filling in a form, about the work result. Successful performance of the task and/or, if appropriate, a desired quality of a product produced are/is thus confirmed by the worker himself/herself. In some cases, a confirmation can be effected by a further person. However, prompt support and/or quality control accompanying the production process are/is not implemented.

Consequently, the quality of the product produced may be greatly dependent on the user's or worker's experience with regard to the task carried out. By way of example, too little experience may lead to a high error rate when carrying out the task and thus to a low quality. On the other hand, very great experience on the part of the worker can also adversely affect the quality, specifically by virtue of the fact that very high experience leads to habituation on the part of the worker and to a decrease in concentration. The lack of concentration can increase the error rate and have an adverse effect on the quality. Manual production without process-accompanying, e.g. technical, support may consequently be dependent on the worker's experience and concentration and thus be susceptible to errors.

### SUMMARY

In various exemplary embodiments, a quality of a handling and/or production task carried out completely or partly manually and of a product produced as a result can be improved by means of adapted information concerning a next work step or concerning next work steps, said information being presented automatically in a process-accompanying manner. To put it another way, the worker can be instructed step by step. Furthermore, a continuous check can be made as to whether the work step was carried out correctly, and a result of the check can be displayed or communicated to the worker.

In various exemplary embodiments, a process support system can be provided which enables quality assurance for workplaces that are currently purely manual. The manual workplaces can be set up for example for manual production, for example for mounting, arranging parts, sorting parts, packaging, maintenance, replacement, disassembly and/or reassembly.

In various exemplary embodiments, a continuous, to put it another way a lasting and uninterrupted, check of the quality of the subprocesses (also designated as “work steps”) can be carried out. Furthermore, information about at least one of the subprocesses to be carried out currently and/or next can be provided for the worker situation-dependently in an adapted manner, for example uninterruptedly. The information can be stored in a processor, for example, and communicated to the worker by means of an information system (also designated as actuator).

In various exemplary embodiments, information about exactly one subsequent subprocess to be performed can be provided for the worker.

In various exemplary embodiments, information about a plurality of subprocesses to be performed, for example successively, can be provided for the worker. By way of example, information about the subsequent two, three or more subprocesses to be performed can be provided, or information about the result of all the subprocesses to be performed.

When expressed illustratively, in various exemplary embodiments, the manual production process can be carried out on the basis of a control loop. In this case, the quality of the subprocesses carried out can be checked continuously, and on the basis of a result of the check the worker can be instructed either to continue with a subsequent subprocess (given a positive result) or else to perform a correction subprocess (given a negative result). In this case, the quality of the subprocesses carried out can be checked for example by means of a comparison of desired stipulations stored for a respective subprocess, for example of at least one desired action or of at least one desired state as result of the respective subprocess, with a currently present state or a currently performed action.

In various exemplary embodiments, at least one sensor can be used to detect the currently present state or the currently performed action. By way of example, it is possible to detect a position of an arranged part, a number of arranged parts, a state, e.g. a temperature of a part, or the like.

In various exemplary embodiments, the sensor can comprise for example an optical sensor, a 3D sensor, a camera for a visible spectral range, a camera for an infrared or near-infrared spectral range, an active pixel sensor, for example a CMOS sensor, a 2D code sensor, for example a bar code sensor or a data matrix code sensor, a 3D detection by means of triangulation or light propagation time measurement or the like, an RFID sensor (also designated as near-field communication sensor), or a wireless communication.

In the event of stored tolerances being exceeded, for example if the detected position deviates from the desired state, that is to say in this case from the desired position, over and above the stored tolerance range, the process support system in various exemplary embodiments can inform the worker about the tolerance being exceeded and/or about the correction subprocess to be carried out. The worker can be informed without significant delay.

In various exemplary embodiments, the worker can be informed by the use of, for example, an optical information system (also designated as visualization system), for example a monitor, a lamp, a projector, a display system in which information is projected into the user's field of view (also designated as “head-up display”), or monitor spectacles, an acoustic information system, for example a loudspeaker, a mechanical information system, for example a vibration generator, a system for generating information for haptic detection, for example Braille, a robot arm, a displacement means, e.g. for automatic, for example coarse, positioning of an object, or any other information system which is designed to inform the worker, for example about a current status of the process or about the subprocess or correction subprocess to be performed.

In various exemplary embodiments, one or a plurality of the information systems mentioned can be used simultaneously or temporally separately.

In various exemplary embodiments, an abundance of detail in the information provided for the worker, also designated as degree of detailing or as degree of information, can be varied. The degree of information can be adapted for example to the worker's experience with regard to the process to be performed. In the case of an experienced worker, the information can be provided for example with a low degree of information, i.e. low abundance of detail. In the case of an inexperienced worker, for example in a training situation or having little experience with the process to be performed, the information can be provided for example with a high degree of information.

In various exemplary embodiments, the worker can select the degree of information himself/herself, for example by means of a menu. The menu can for example be introduced into the worker's work area and be operable by means of gesture recognition (which is also designated as a “virtual menu”), or the menu can for example be arranged in the work area and be operable by means of touch, e.g. by the pressing of keys.

In various exemplary embodiments, the menu can also be used for a selection of other items of information, for example for the selection of the process to be performed, for a presentation of general information about the process to be performed, for a selection when various possible options are provided, etc.

In various exemplary embodiments, the checking of the quality of the subprocesses carried out, in other words the checking of the correct performance of work steps, can be effected independently of the worker's experience.

In various exemplary embodiments, the process support system can be designed such that it supports processes and/or subprocesses which are performed in a fixed work area, for example on a table. The parts of the process support system, e.g. the processor, the comparator, the sensor and/or the actuator, can be fixedly mounted, for example; for example, the sensor and the actuator can be mounted near and/or above the work area by means of a mount.

In various exemplary embodiments, the process support system can be designed such that it supports processes and/or subprocesses which are performed in a mobile work area. The process support system can support for example processes and/or subprocesses which are performed on a workpiece to be processed while the workpiece is being conveyed, for example on a conveying installation. The conveyed workpiece could be a vehicle, for example, on which processes and/or subprocesses are performed during production on a conveying installation. To put it another way, a fixed work area, for example a table, is not necessary for use of the process support system.

In various exemplary embodiments, the process support system itself can be at least partly mobile; for example, the sensor and/or the actuator can be designed to be movable. The sensor and/or the actuator can be concomitantly moved with the workpiece, for example. The sensor and/or the actuator can be mounted on a movable, if appropriate driven, arm, for example. As a result, the sensor and/or the actuator, and thus a detection region of the sensor and/or a display region of the actuator, can be kept at a fixed distance from the workpiece for example within a predetermined section.

In various exemplary embodiments, an action region of the process support system can be mobile; for example, the detection region of the sensor and/or the display region of the actuator can be designed to be movable, without the sensor and/or the actuator themselves/itself being moved. The detection region of the sensor and/or the display region of the actuator can be concomitantly moved with the workpiece, for example. For example, an optical unit in the sensor and/or an optical unit in the actuator can be controlled by open-loop or closed-loop control such that the detection region of the sensor, for example an imagined region of a camera, and/or the display region of the actuator, for example a projection region of a projector, concomitantly move with the workpiece.

In various exemplary embodiments, the handling and/or production task carried out completely or partly manually can be supplemented by subprocesses performed automatically, for example by means of an automation system. Depending on the number or extent of the subprocesses performed by means of the automation system, a degree of automation can be scalable. By way of example, a low degree of automation can be realized by use of partly automated systems or no or few automation systems, and a high degree of automation can be realized by use of many automation systems and/or by many subprocesses being carried out by the automation system(s).

Exemplary embodiments of the invention are illustrated in the figures and are explained in greater detail below.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A and FIG. 1B show a schematic illustration of a process support system in accordance with various exemplary embodiments;

FIG. 2A shows a schematic illustration of a process support system in accordance with various exemplary embodiments;

FIG. 2B shows a partial view of a process support system in accordance with various exemplary embodiments;

FIG. 2C shows a schematic illustration of a process support system in accordance with various exemplary embodiments;

FIG. 3 shows a signal flow chart of a process support system in accordance with various exemplary embodiments;

FIG. 4A and FIG. 4B show a work area during performance of a process with support by a process support system in accordance with various exemplary embodiments;

FIG. 5A to FIG. 5D show a work area during performance of a process with support by a process support system in accordance with various exemplary embodiments;

FIG. 6A to FIG. 6H show a work area during processing of an object, wherein a method for supporting a process for processing the object in accordance with various exemplary embodiments is performed;

FIG. 7A to FIG. 7C show a work area before an object is processed, wherein a method for supporting a process for processing the object in accordance with various exemplary embodiments is performed, and wherein depth information images are also additionally illustrated in FIG. 7A and in FIG. 7B;

FIG. 8A to FIG. 8C show (partial) views of work areas during performance of a process with support by a process support system in accordance with various exemplary embodiments;

FIG. 9A shows a flow chart illustrating a method for supporting a process for processing an object in accordance with various exemplary embodiments; and

FIG. 10A to FIG. 10C show flow charts of processes which can be supported by means of a method for supporting a process for processing an object in accordance with various exemplary embodiments or by means of a process support system in accordance with various exemplary embodiments.

### DETAILED DESCRIPTION

In the following detailed description, reference is made to the accompanying drawings, which form part of this description and show for illustration purposes specific embodiments in which the invention can be implemented. In this regard, direction terminology such as, for instance, “at the top”, “at the bottom”, “at the front”, “at the back”, “front”, “rear”, etc. is used with respect to the orientation of the figure(s) described. Since component parts of embodiments can be positioned in a number of different orientations, the direction terminology serves for illustration and is not restrictive in any way whatsoever. It goes without saying that other embodiments can be used and structural or logical changes can be made, without departing from the scope of protection of the present invention. It goes without saying that the features of the various exemplary embodiments described herein can be combined with one another, unless specifically indicated otherwise. Therefore, the following detailed description should not be interpreted in a restrictive sense, and the scope of protection of the present invention is defined by the appended claims.

In the context of this description, the terms “connected” and “coupled” are used to describe both a direct and an indirect connection and a direct or indirect coupling. In the figures, identical or similar elements are provided with identical reference signs insofar as this is expedient.

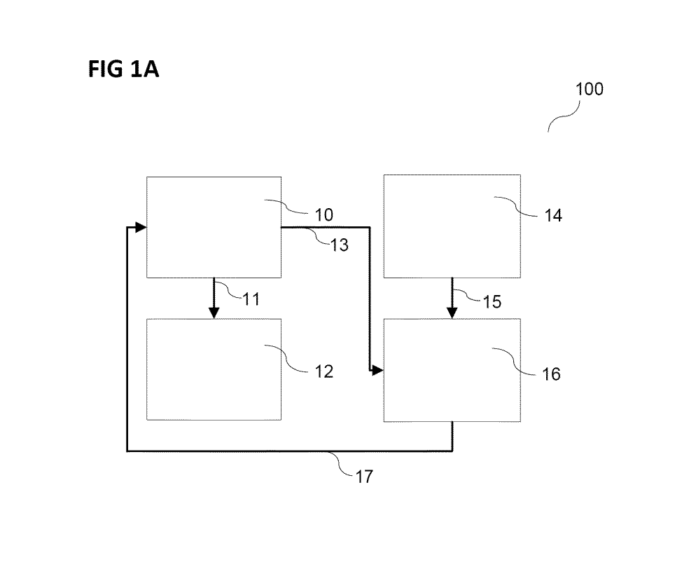

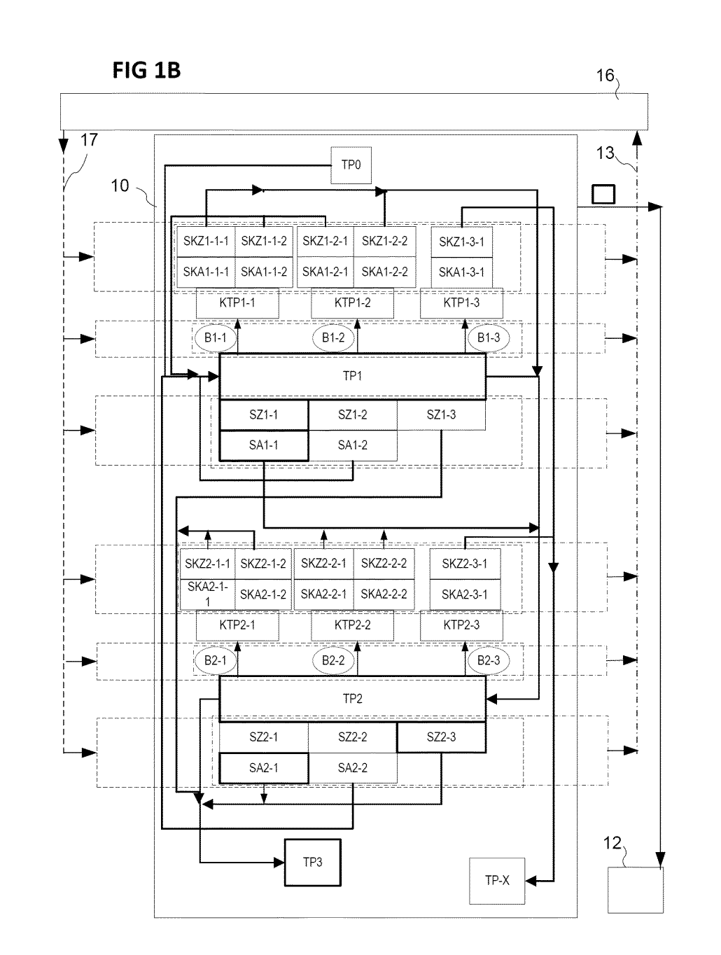

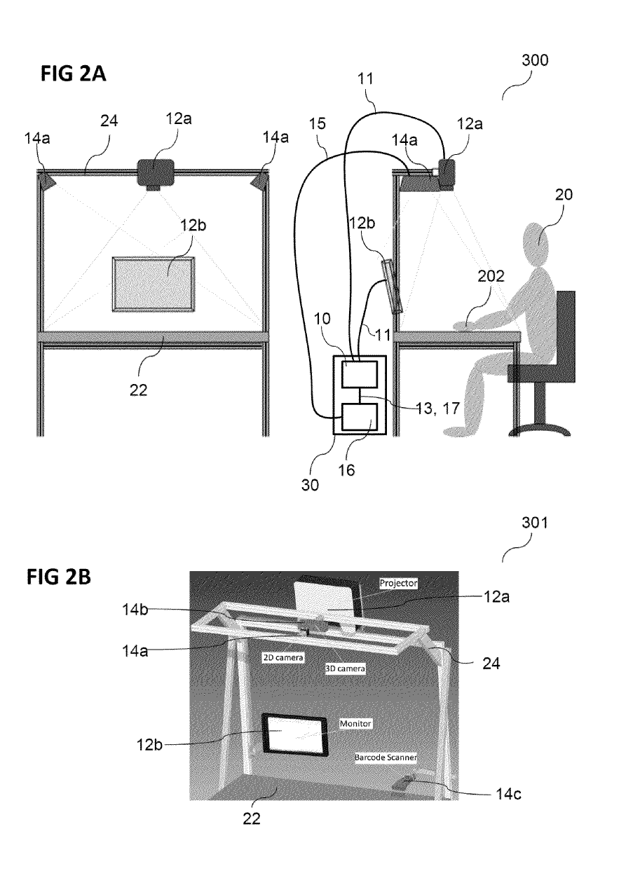

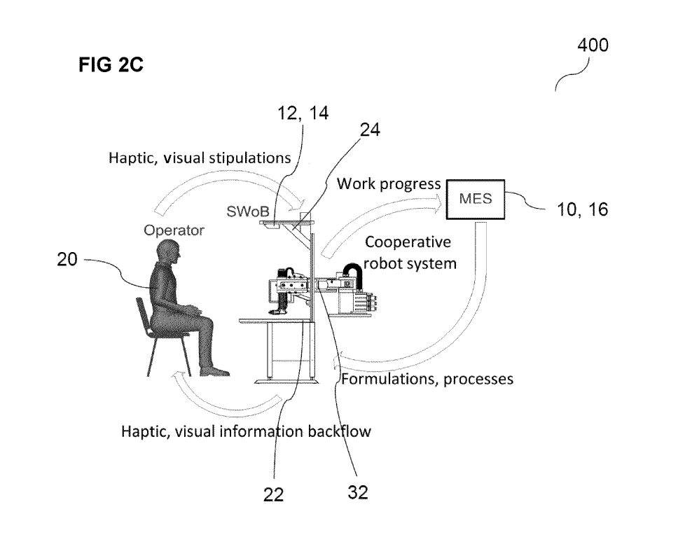

FIG. 2A shows a schematic illustration of a process support system 100 in accordance with various exemplary embodiments, and FIG. 1B shows a schematic illustration of a processor 10 of the process support system 100 in accordance with various exemplary embodiments.

In various exemplary embodiments, the process support system 100 can comprise the processor 10, an actuator 12, a sensor 14 and a comparator 16. The processor 10 can provide the actuator 12 with information, symbolized by a path 11. The processor 10 can provide the comparator 16 with information, symbolized by a path 13. The comparator 16 can provide the processor 10 with information, symbolized by a path 17. The sensor 14 can provide the comparator 16 with information, symbolized by a path 15.

The processor 10 can be part of a data processing system, for example. The processor 10 can be a stand-alone processor 10. The processor 10 can comprise a processor unit. The processor 10 can comprise a processing unit, for example a central processing unit (CPU) or a microprocessor. The processor 10 can comprise a so-called “distributed system”, for example a plurality of interacting processors which have no shared memory and communicate with one another via messages. The processor 10 can comprise a storage unit, for example a primary memory and/or a main memory and/or a hard disk. The processor 10 can comprise a database. The processor 10 can comprise devices which are designed to provide information to the processor 10, for example for inputting data for storage of the data in or on the processor 10. The processor 10 can comprise devices which are designed to provide information by the processor 10, for example for outputting data stored in or on the processor 10. The information can be provided for the comparator 16 and/or the actuator 12, for example.

In various exemplary embodiments, the processor 10 can be designed to provide a predefined sequence of subprocesses TP0, TP1, TP2, TP3 of a process for processing an object, wherein the sequence of subprocesses TP0, TP1, TP2, TP3 of the process can be stored, and wherein each subprocess TP0, TP1, TP2, TP3 can be assigned an indication about at least one desired action SA1-1, SA1-2, SA2-1, SA2-2 and/or about at least one desired state SZ1-1, SZ1-2, SZ1-3, SZ2-1, SZ2-2, SZ2-3 as result of the respective subprocess TP1 or TP2.

The subprocesses are numbered in accordance with the predefined sequence (TP0, TP1, etc.) in accordance with various exemplary embodiments in FIG. 1B. A subprocess “Termination of the process” is identified by TP-X. FIG. 1B is intended merely to serve to illustrate certain progressions, selection possibilities, interactions, etc., and does not represent a complete schematic of the exemplary process. The respectively assigned desired actions are designated by SA, followed by the number of the subprocess to which they are assigned, that is to say e.g. desired actions SA1-1, SA1-2 etc. The same correspondingly applies to the desired states SZ1-1, SZ1-2, etc., correction subprocesses KTP1-1, KTP1-2 etc., desired correction states SKZ1-1-1, SKZ1-2-1, etc., desired correction actions SKA1-1-1, SKA1-2-1, etc., and conditions B1-1, B1-2, etc. In a manner corresponding to the plurality of correction subprocesses assigned to a subprocess, the numbering for the subprocess to which the correction subprocess is assigned is also followed by an appended numbering for in each case one of the alternative correction subprocesses. In a manner corresponding to the plurality of desired correction states and/or desired correction actions assigned to a correction subprocess, the numbering for the alternative of the correction subprocess is also followed by an appended numbering for in each case one of the alternative desired correction states and/or in each case one of the alternative desired correction actions. Insofar as hereinafter no specific subprocess is intended to be distinguished from another, but rather one or more of the plurality of subprocesses is meant, the numbering is omitted for the sake of brevity, i.e. the subprocess is designated only as subprocess TP e.g. instead of subprocess TP0, TP1, TP2, TP3. The same correspondingly applies, mutatis mutandis, to the desired states SZ, the desired actions SA, the conditions B, the correction subprocesses KTP, the desired correction actions SKA and the desired correction states SKZ.

In various exemplary embodiments, a plurality of subprocesses TP of a process for processing an object can be stored in or on the processor 10.

In various exemplary embodiments, the processor 10 can be designed to provide a predefined sequence of subprocesses TP of a process for processing an object, wherein the sequence of subprocesses TP of the process is stored, and wherein each subprocess TP is assigned an indication about at least one desired action SA and/or about at least one desired state SZ as result of the respective subprocess TP.

In various exemplary embodiments, at least one predefined sequence of the plurality of subprocesses TP can be stored in or on the processor 10.

In various exemplary embodiments, in or on the processor 10, at least one subsequent subprocess TP of the plurality of subprocesses TP can be assigned to each subprocess TP of the plurality of subprocesses TP (apart from a last subprocess TPz, wherein the numbering “z” denotes the last subprocess) and stored.

In various exemplary embodiments, in or on the processor 10, exactly one subsequent subprocess TP can be assigned to each subprocess TP of the plurality of subprocesses TP (apart from a last subprocess TP). To put it another way, the predefined sequence of subprocesses TP can be configured so as to result in a linear, unbranched succession of subprocesses TP.

In various exemplary embodiments, in or on the processor 10, an assignment of a subsequent subprocess TP can be linked to one or more than one condition B which must be met in order that the subsequent subprocess TP is provided for the user as subsequent subprocess TP to be performed. The subsequent subprocess TP can be provided for the user by means of the actuator 12, for example.

In various exemplary embodiments, in or on the processor 10, a rank order can be assigned to a plurality of subsequent subprocesses TP for which the linked condition B or the linked conditions B can be met equally. To put it another way, a rank order can be assigned and stored in the case of two or more subprocesses TP which can be performed because the respective conditions B for performing them are met. The processor 10 can provide the highest ranked subprocess TP, the plurality of subprocesses TP, or a subset of the plurality of subprocesses TP as subsequent subprocess TP.

In various exemplary embodiments, at least one desired action SA and/or at least one desired state SZ can be assigned to a subprocess TP.

In various exemplary embodiments, a plurality of desired actions SA and/or desired states SZ can be assigned to a subprocess TP, for example when the plurality of possible subsequent subprocesses TP are present. To put it another way, a subprocess TP can be assigned not only the action and/or the state as desired action SA and/or desired state SZ which would be performed and/or attained from said subprocess TP being performed, but also the actions which would be performed and/or attained upon the other equally possible subprocesses TP being performed can be assigned to the aforesaid subprocess TP as desired action SA and/or desired state SZ (and this also applies, mutandis mutatis, to the other subprocesses TP).

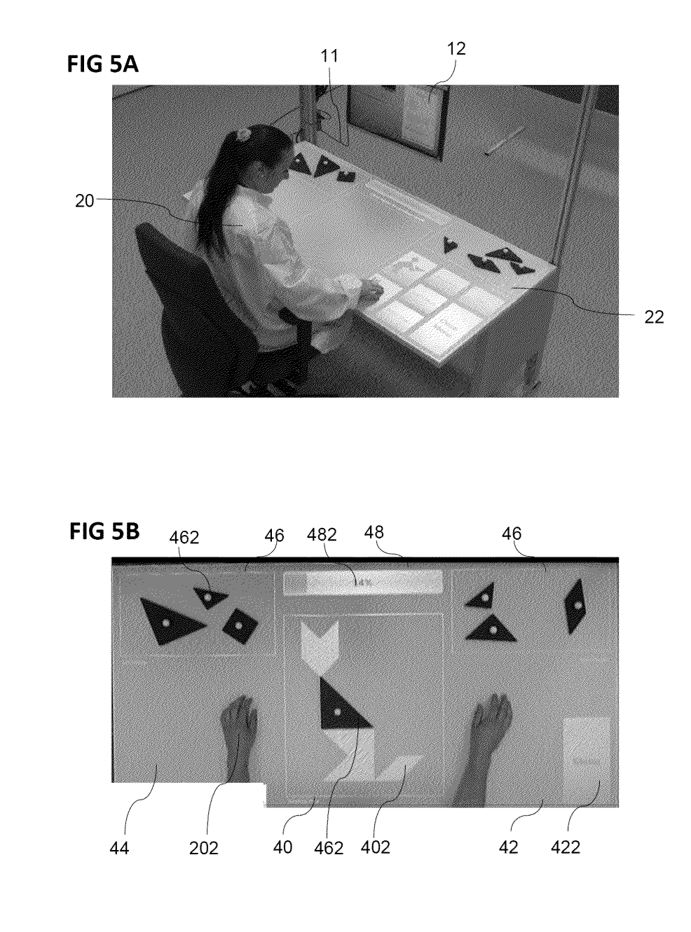

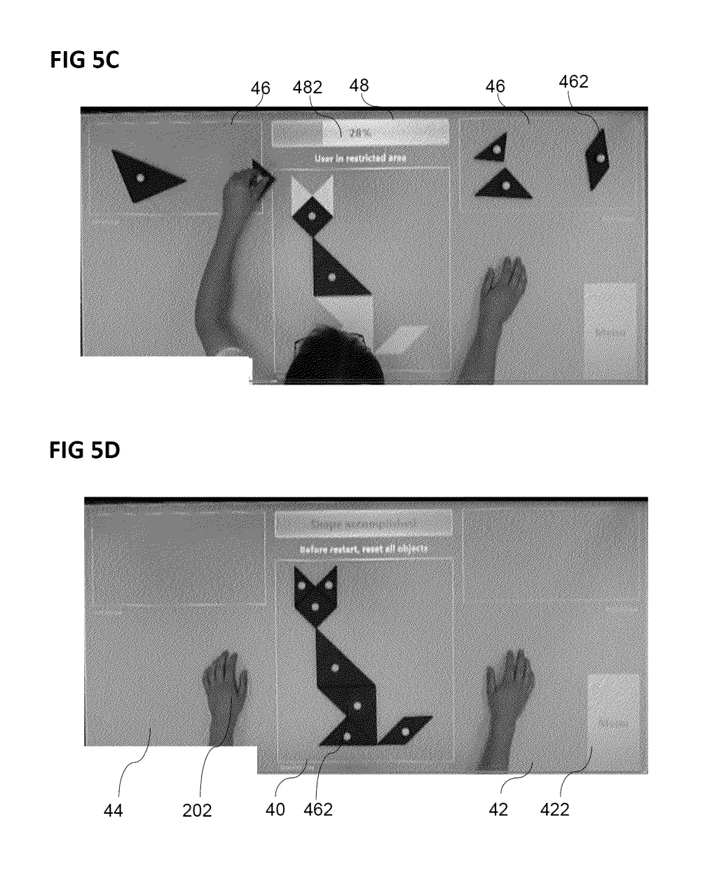

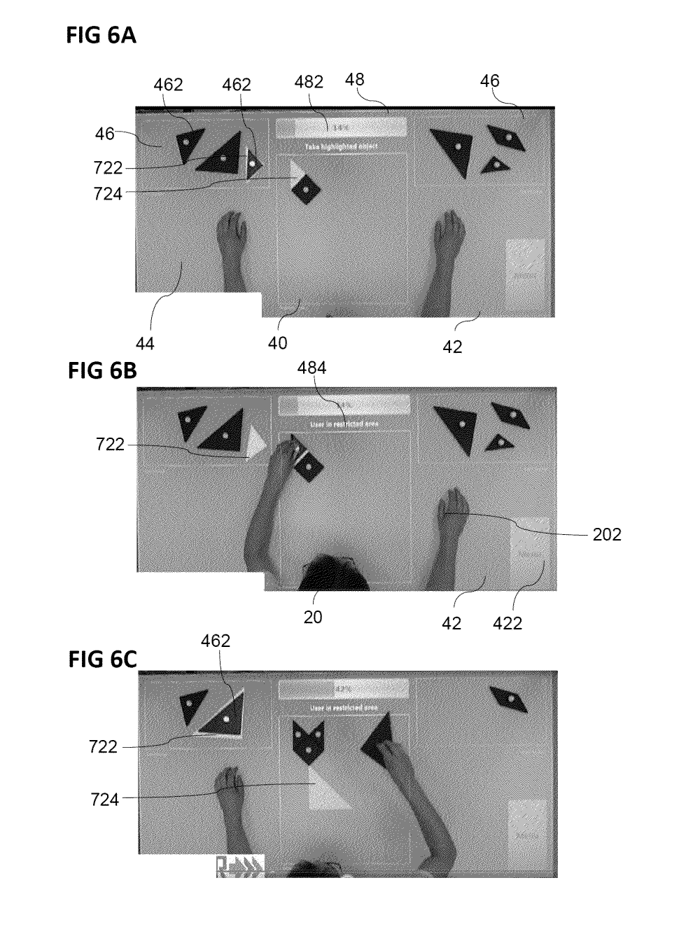

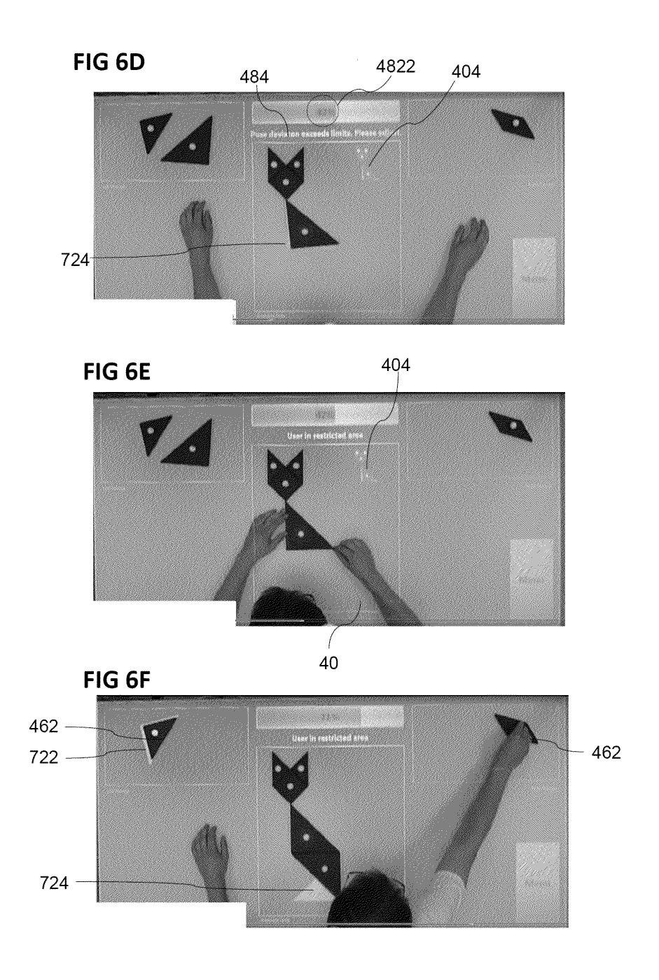

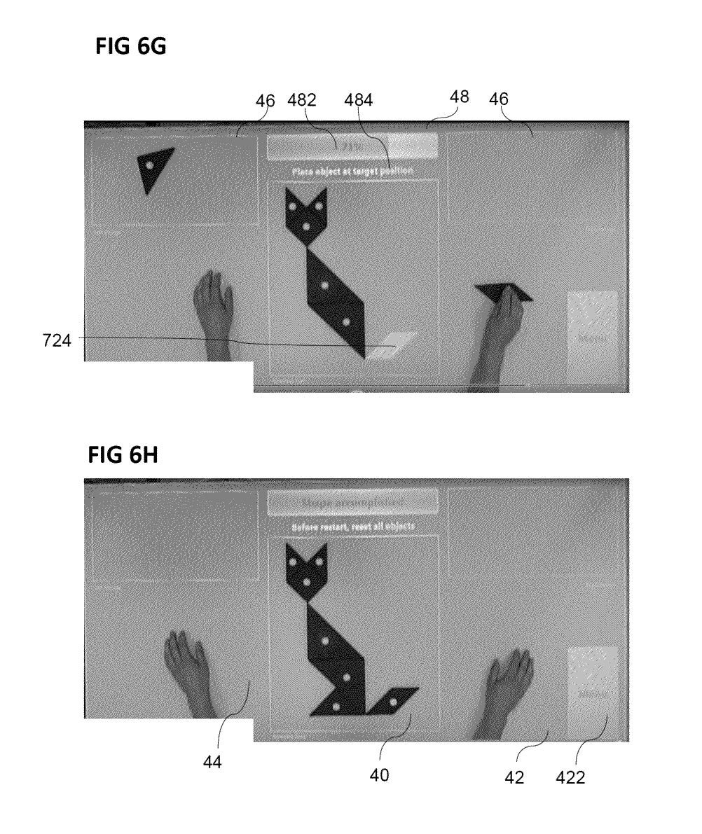

By way of example, a process for arranging two parts, part A and part B, in which it is unimportant whether part A is arranged first or part B is arranged first, can comprise a first subprocess TP1 “Arranging part A” and a second subprocess TP2 “Arranging part B”. Both arranging part A (SA1-1) and arranging part B (SA1-2) can be assigned as desired actions to said subprocess TP1, and a (correctly arranged) part A (SZ1-1) and a (correctly arranged) part B (SZ1-2) can be assigned as desired states. Furthermore, the first subprocess TP1 can also be assigned a desired state SZ1-3 in which, for example, part A and part B are correctly arranged. Accordingly, the first subprocess TP1 “Arranging part A” can be assigned as subsequent subprocesses TP both a subprocess TP2 “Arranging part B” (for the case where part A is actually arranged in the first subprocess) and a subprocess TP1 “Arranging part A” (for the case where part B is arranged instead of part A, which constitutes an equivalent alternative). Given arranged part A (i.e. given correctly performed desired action SA1-1 “Arranging part A”) and/or correctly arranged part A, that is to say presence of the desired state SZ1-1 “correctly arranged part A”, the subprocess TP2 “Arranging part B” would then be provided as subsequent subprocess. The opposite situation would apply, mutatis mutandis, if part B were arranged in the first subprocess. In this respect, also see the exemplary embodiments in FIG. 5A to FIG. 5D and FIG. 6A to FIG. 6H.

In various exemplary embodiments, exactly one desired action SA and/or exactly one desired state SZ can be assigned to a subprocess TP.

By way of example, a process for arranging two parts, part C and part D, in which it is necessary to arrange part C before part D, can comprise a first subprocess “Arranging part C”. “Arranging part C” can be assigned as desired action to this subprocess, and a “correctly arranged part C” can be assigned as desired state. Accordingly, the first subprocess “Arranging part C” can be assigned as subsequent subprocesses “Arranging part D”. A condition for providing the subprocess “Arranging part D” as subsequent subprocess would be the presence of the desired state (correctly arranged part C) and/or the correctly performed desired action of arranging part C.

In various exemplary embodiments, exactly one desired action SA and/or exactly one desired state SZ can be assigned to each subprocess TP.

In various exemplary embodiments, a tolerance range can be assigned to the at least one desired action SA in or on the processor 10.

In various exemplary embodiments, a tolerance range can be assigned to the at least one desired state SZ in or on the processor 10.

The tolerance range can be arrange which indicates what action ought still to be correspondingly rated as the desired action SA, and/or what state ought still to be correspondingly rated as the desired state SZ.

In various exemplary embodiments, a process can comprise one or a plurality of subprocesses TP to which exactly one subsequent subprocess TP is assigned, and/or one or a plurality of subprocesses TP to which a plurality of subsequent subprocesses TP are assigned.

In various exemplary embodiments, a process can comprise one or a plurality of subprocesses TP to which exactly one desired action SA and/or exactly one desired state SZ are/is assigned, and/or one or a plurality of subprocesses TP to which a plurality of desired actions SA and/or a plurality of desired states SZ are assigned.

In various exemplary embodiments, a correction subprocess KTP can be designed to correct an action carried out as part of a subprocess TP and/or a state attained as a result of the action, which action and/or which state do(es) not correspond to a desired action SA and/or a desired state SZ. By way of example, the correction can be effected in such a way that one of the desired actions SA is carried out and/or one of the desired states SZ is attained, or the correction can be effected in such a way that one that is different than one of the desired actions SA is carried out and/or one that is different than one of the desired states SZ is attained.

In various exemplary embodiments, the at least one correction subprocess KTP can be stored in or on the processor 10.

In various exemplary embodiments, the correction subprocess KTP can be assigned to at least one subprocess TP from the plurality of subprocesses TP and stored in or on the processor 10.

In various exemplary embodiments, the correction subprocess KTP can be assigned to exactly one subprocess TP from the plurality of subprocesses TP and stored in or on the processor 10. By way of example, the correction subprocess KTP can be so specific that it is designed only for correcting exactly one subprocess TP or for correcting the desired state SZ assigned to the subprocess TP and/or the desired action SA assigned to the subprocess TP.

In various exemplary embodiments, the correction subprocess KTP can be assigned to more than one subprocess TP from the plurality of subprocesses TP and stored in or on the processor 10. By way of example, the correction subprocess KTP can be so general that it is designed for correcting a plurality of subprocesses TP or for correcting the desired states SZ assigned to the subprocesses TP and/or the desired actions SA assigned to the subprocesses TP. In the example from FIG. 1B, for the subprocess TP1 “Arranging part A” a correction subprocess KTP1-3 “correcting a defect” under a condition B1-3 that the part A to be arranged is defective can be provided as correction subprocess to be performed, assigned desired correction action SKA1-3-1 can be “removing the defective part”, assigned desired correction state SKZ1-3-1 can be a state in which the defective part is removed, and the assigned subsequent subprocess TP-X can be the termination of the process. Equally, however, for the subprocess TP2 “Arranging part B”, a correction subprocess KTP2-3 under a condition B2-3 that the part B to be arranged is defective can also be provided as correction subprocess to be performed, assigned desired correction action SKA1-3-1 can once again be “removing the defective part”, assigned desired correction state SKZ1-3-1 can be a state in which the defective part is removed, and the assigned subsequent subprocess TP-X can be the termination of the process. Consequently, “removing the defective part” constitutes one example of a correction subprocess KTP which can be assigned as correction subprocess KTP to different subprocesses TP.

In various exemplary embodiments, each correction subprocess KTP can be assigned to at least one subprocess TP from the plurality of subprocesses TP and stored in or on the processor 10.

In various exemplary embodiments, each correction subprocess KTP can be assigned to exactly one subprocess TP from the plurality of subprocesses TP and stored in or on the processor 10.

In various exemplary embodiments, each correction subprocess KTP can be assigned to more than one subprocess TP from the plurality of subprocesses TP and stored in or on the processor 10.

In various exemplary embodiments, at least one correction subprocess KTP can be assigned to the at least one subprocess TP.

In various exemplary embodiments, exactly one correction subprocess KTP can be assigned to the at least one subprocess TP. By way of example, the subprocess TP can lead to such a definite state that deviation from the assigned desired state SZ can be corrected only in one way, for example by the replacement of a part affected by the deviation. The assigned correction subprocess KTP can then be “replacing the part” for example.

In various exemplary embodiments, a plurality of correction subprocesses KTP can be assigned to the at least one subprocess TP. By way of example, the subprocess TP can have a plurality of different possible deviations from the assigned desired action SA and/or from the assigned desired state SZ. The different possible deviations can in each case require a different correction subprocess KTP for a correction. Taking up the above example of arranging parts C and D (order not interchangeable), the subprocess “Arranging part C” can afford various possibilities for deviating from the assigned desired action (arranging part C) and/or from the assigned desired state (correctly arranged part C). By way of example, part D can be arranged instead of part C, part C can be arranged incorrectly at its location, or part C can break in the course of being arranged. The plurality of assigned correction subprocesses KTP can comprise for example removing part D and replacing it by part C, correcting the arrangement of part C at its location, or replacing the broken part C by a new part C.

In various exemplary embodiments, exactly one correction subprocess KTP can be assigned to each subprocess TP.

In various exemplary embodiments, a plurality of correction subprocesses KTP can be assigned to each subprocess TP.

In various exemplary embodiments, a process can comprise at least one subprocess TP to which exactly one correction subprocess KTP is assigned, and/or at least one subprocess TP to which a plurality of correction subprocesses KTP are assigned.

In various exemplary embodiments, the at least one correction subprocess KTP, in addition to presence of a deviation from the assigned desired action SA and/or the assigned desired state SZ, can be assigned a condition B which must be met in order that the correction subprocess KTP assigned to the subprocess TP is provided as correction subprocess KTP to be performed. The correction subprocess KTP to be performed can be provided for the user. The correction subprocess KTP to be performed can be provided for the user by means of the actuator 12, for example.

In various exemplary embodiments, the conditions assigned to different correction subprocesses KTP can be different, for example in the case where the plurality of correction subprocesses KTP are assigned to the subprocess TP. By way of example, in the above example of arranging parts C and D, the correction subprocesses KTP assigned to the first subprocess “Arranging part C” can have (in addition to the condition that part C was not arranged by means of a desired action and/or is not in the desired state), for example, the following conditions as well: “location of part C occupied, but not by C” (assigned to a correction subprocess “removing part D and replacing it by part C”), “location of part C is occupied, but position outside tolerated limits” (assigned to a correction subprocess “correcting the arrangement of part C at its location”), and “Arranged part defective” (assigned to a correction subprocess “replacing the broken part by a new part”).

In various exemplary embodiments, the conditions which are assigned to different correction subprocesses KTP can be identical, for example in the case where the plurality of subprocesses TP are assigned to the correction subprocess KTP. By way of example, as described above, the condition “Arranged part defective” can be assigned to the correction subprocess “replacing the broken part by a new part”. Each subprocess TP for which there is a possibility that the assigned desired state SZ is not attained by virtue of the fact that the arranged part has a defect or breaks can be assigned the correction subprocess “replacing the broken part by a new part”. Furthermore, even further correction subprocesses KTP can be assigned to the subprocess TP. The correction subprocess “replacing the broken part by a new part” can be provided by the processor 10 as correction subprocess KTP to be performed if the conditions are met that the desired state SZ assigned to the subprocess TP was not attained and/or the action assigned to the desired state SZ was not performed, and that the arranged part is defective.

To put it another way, in various exemplary embodiments, the processor 10 can be designed such that it provides the assigned correction subprocess KTP if it receives information that the currently performed subprocess or the subprocess concluded last was not performed correctly, for example because one that is different than one of the desired actions SA assigned to the subprocess TP (and thus an incorrect action) was performed, or because one that is different than one of the desired states SZ assigned to the subprocess TP (and thus an incorrect state) was attained.

To put it another way, in various exemplary embodiments, the correction subprocess KTP can be provided by the processor 10, for example for the user by means of the actuator 12, in order that the user can correct the subprocess TP not performed correctly or the action not corresponding to the desired action SA or the incorrect attained state or the state not corresponding to the desired state SZ.

In various exemplary embodiments, the processor 10 can furthermore be designed to assign to the correction subprocess KTP an indication about at least one desired correction action SKA and/or at least one desired correction state SKZ as result of the correction subprocess KTP.

In various exemplary embodiments, a plurality of desired correction actions SKA and/or desired correction states SKZ can be assigned to a correction subprocess KTP, for example when a plurality of possible correction subprocesses KTP are present and/or when a plurality of desired actions SA and/or desired states SZ are present. To put it another way, a correction subprocess KTP can be assigned not only the correction action and/or the correction state as desired correction action SKA and/or desired correction state SKZ which would be performed and/or attained upon said correction subprocess KTP being performed, but for example also the correction actions and/or correction states which would be performed and/or attained upon the other equally possible correction subprocesses KTP being performed can be assigned to the aforesaid subprocess TP as desired correction action SKA and/or desired correction state SKZ (and this also applies, mutatis mutandis, to the other correction subprocesses KTP).

By way of example, in the above-described process for arranging two parts, part A and part B, in which it is unimportant whether part A (TP1) is arranged first or part B (TP2) is arranged first, arranging part A at the location of part B can have the effect that none of the desired states (part A correctly at location of part A, SZ1-1, or part B correctly at location of part B, SZ1-2) assigned to the first subprocess “Arranging part A” is attained. An assigned correction subprocess KTP1-1 can comprise for example removing part A from the location of part B and correctly arranging part A. An assigned desired correction action KTP1-1-2 can comprise for example taking away part A from the location of part B and correctly arranging part B at its location. In accordance with this example, a correctly arranged part B (corresponding desired correction state SKZ1-1-2) is one of the desired states, SZ1-2, of the first subprocess TP1 since the order of the arrangement of part A and part B is interchangeable. That is to say that the desired correction state SKZ1-1-2 and the desired state SZ1-2 are identical in this case. The subsequent subprocess TP1 assigned to the desired correction state SK1-1-2 would be arranging part A.

A further assigned desired correction action SKA1-1-1 can comprise for example shifting the part A from the location of part B to its correct position, and the corresponding desired correction state SKZ1-1-1 would be “part A correctly at location of part A” and would correspond to the desired state SZ1-1 assigned to TP1. The subsequent subprocess TP2 assigned to this desired correction state would be arranging part B. The desired correction states SKZ1-1-1 and SKZ1-1-2 assigned to the exemplary correction subprocess KTP1-1 can therefore comprise “part A correctly at location of part A” (SKZ1-1-1) and “part B correctly at the location of part B” (SKZ1-1-2).

In various exemplary embodiments, correction subprocesses KTP can be assigned desired correction action SKA and/or desired correction states SKZ which correspond to none of the assigned desired states SZ and/or desired actions SA of the subprocess TP. This is illustrated in the above-described example concerning the correction subprocess KTP1-3 “correcting a defect”. The desired correction action SKA1-3-1 “removing the defective part” and/or the desired correction state SKZ1-3-1 (state in which the defective part is removed) are/is assigned to the correction subprocess KTP1-3 and correspond(s) to none of the desired actions SA1-1 or SA1-2 and to none of the desired states SZ1-1, SZ1-2 or SZ1-3.

In various exemplary embodiments, exactly one desired correction action SKA and/or exactly one desired correction state SKZ can be assigned to a correction subprocess KTP.

In various exemplary embodiments, exactly one desired correction action SKA and/or exactly one desired correction state SKZ can be assigned to each correction subprocess KTP.

In various exemplary embodiments, a subprocess TP can be assigned at least one correction subprocess KTP with exactly one desired correction action SKA and/or exactly one desired correction state SKZ and/or at least one correction subprocess KTP with more than one desired correction action SKA and/or more than one desired correction state SKZ.

The process support system 100 can furthermore comprise at least one sensor 14.

In various exemplary embodiments, the at least one sensor 14 can be designed for detecting the action carried out by the user and/or the state on account of the action carried out by the user. To put it another way, the at least one sensor 14 can be designed to detect the action of the user and/or the state which the user brings about by the action carried out by said user.

In various exemplary embodiments, the sensor 14 can comprise an arbitrary system 14 designed to detect the action carried out by the user and/or the state on account of the action carried out by the user.

The action and/or the state can be detected in such a way that information about the action and/or about the state can be provided. The information about the action and/or about the state can enable a comparison with a desired action, a desired state, a desired correction action and/or a desired correction state. To put it another way, the action or the state, after the detection thereof, can be provided for the comparator 16, for example.

In various exemplary embodiments, the sensor 14 can be designed to carry out a temporal succession of individual detections, such that the temporal succession of the individual detections can be used to assign a temporal change in the detected object and/or a temporal change in a detected scene to one of the actions, e.g. the action of the user.

In various exemplary embodiments, the sensor 14 can furthermore be designed to detect an action of an automatic device, for example of a robot, and/or a state which the automatic device brings about by the action carried out by it.

In various exemplary embodiments, the action can be performed and detected in connection with one of the subprocesses of the process. In various exemplary embodiments, the action can be performed and detected in connection with the correction subprocess.

In various exemplary embodiments, the state can be attained and detected in connection with one of the subprocesses of the process. In various exemplary embodiments, the state can be attained and detected in connection with the correction subprocess.

In various exemplary embodiments, the sensor 14 can be designed to provide what it has detected, for example information, an image, or the like. What the sensor has detected can be provided for the comparator 16, for example.

In various exemplary embodiments, the sensor 14 can be designed to provide what it has detected in an unaltered form, also designated as raw data, for the comparator 16, for example.

In various exemplary embodiments, the sensor 14 can be designed at least partly to process the raw data and to provide processed data, for example for the comparator 16. By way of example, the sensor 14 can convert intensity values detected by a thermal camera 14 into temperature values and provide the temperature values, for example a two-dimensional image in which pixel values correspond directly to a temperature, for example the temperature in the Celsius unit.

In various exemplary embodiments, what the sensor 14 has detected can be provided for the user, for example for information purposes.

In various exemplary embodiments, the sensor 14 can comprise an optical sensor 14.

The sensor 14 can comprise for example a camera for recording single- or multicolored two-dimensional images, for example a CMOS sensor. The recorded wavelengths can be in the visual or near-infrared wavelength range, for example.

The sensor 14 can comprise for example a system for obtaining spatial, i.e. three-dimensional, information. By way of example, the sensor can comprise a camera system 14, e.g. a stereo camera 14, for generating single- or multicolored three-dimensional images and/or for calculating distance information (the distance between the camera system 14 and the object) on the basis of two individual images recorded simultaneously from two different directions by means of the stereo camera.

In various exemplary embodiments, the sensor 14 can comprise a triangulation system 14. The triangulation system 14 can be designed, for example, to image a predetermined pattern, for example by means of a light source, onto an object, to record the pattern scattered by the object and to derive therefrom the distance information (the distance between the camera and an impingement location of each point of the imaged pattern).

In various exemplary embodiments, the sensor 14 can comprise a system 14 which is designed to determine the distance to the object, or the distance between the sensor 14 and the object, by means of a propagation time measurement of light with which the object is illuminated.

Any system which obtains three-dimensional information according to one of the methods described above and represents it in the form of two-dimensional (for example color-coded) images or three-dimensional data cubes can be designated as a “3D camera”.

In various exemplary embodiments, the sensor 14 can comprise an interferometer 14. The interferometer 14 can be designed, for example, to determine differences in distance between the objects or object points in an imaged area.

In various exemplary embodiments, the sensor 14 can comprise a thermal imaging camera 14. The thermal imaging camera 14 can be designed to assign temperature values to points on the object in its imaging region. The thermal imaging camera 14 can furthermore be designed to provide two-dimensional false color representations of a temperature distribution. The temperature distribution, the temperature value or the like can be provided for the comparator 16, for example.

In various exemplary embodiments, the sensor 14 can comprise a code sensor 14 for detecting two-dimensional codes, for example a bar code sensor 14 or a DMX code sensor 14. To put it another way, the sensor 14 can be designed to detect information provided in a manner coded in a two-dimensional code, for example in a bar code or a DMX code, and, if appropriate, to forward said information or to provide it, for example to provide it in decoded form.

In various exemplary embodiments, the sensor 14 can comprise an RFID sensor 14. The sensor 14 can comprise a reader 14 designed to detect an RFID transponder, for example an RFID transponder arranged on the object, and to read out and provide information stored in the RFID transponder. The information can be provided for the comparator 16, for example. The RFID transponder and the RFID reader 14 can be designed for near field communication by means of radio waves.

In various exemplary embodiments, the sensor 14 can comprise a receiver for wireless communication, for example a radio signal receiver 14. The radio signal receiver 14 can be designed to detect information communicated wirelessly, for example by means of radio, and to provide said information, for example in order to provide it for the comparator 16.

In various exemplary embodiments, the sensor 14 can comprise a microphone 14. The microphone 14 can be designed to detect acoustic information and to provide it, for example in order to provide it for the comparator 16.

In various exemplary embodiments, the comparator 16 can be part of a data processing system. The comparator 16 can comprise a processing unit, for example a central processing unit (CPU) and/or a microprocessor. The comparator 16 can comprise a so-called “distributed system”. The comparator 16 can comprise a storage unit, for example a primary memory and/or a main memory and/or a hard disk. Some or all parts of the comparator 16 can be the same as those of the processor 10. Some or all parts of the comparator can differ from those of the processor 10. The comparator 16 can comprise for example a computer having a computer program which is designed to compare information provided by the sensor 14 with the at least one desired state SZ provided by the processor 10 and/or with the at least one desired action SA or with the at least one desired correction state and/or with the at least one desired correction action. The provision of information to the comparator 16 with regard to the desired (correction) states S(K)Z and/or the desired (correction) actions S(K)A and the conditions B by means of the processor 10 is illustrated on the basis of connections 13 in FIG. 1A, and in FIG. 1B on the basis of dash-dotted frames around symbols for the desired actions SA, desired states SZ, desired correction action SKA, desired correction state SKZ and conditions B, which are connected to arrows facing in the direction of the connection 13 leading to the comparator 16.

In various exemplary embodiments, the comparator 16 can be part of the same data processing system as the processor 10. In various exemplary embodiments, the comparator 16 can comprise a stand-alone system or can be part of a different data processing system than the processor 10.

In various exemplary embodiments, the processor 10 can be designed in such a way that, for the case where a comparison performed by the comparator 16 reveals that the subprocess TP was not performed correctly by the user, said processor provides a correction subprocess KTP, which is performed by the user, and, for the case where the comparison reveals that the subprocess TP was performed correctly by the user, said processor provides a subprocess TP which succeeds the subprocess TP in the sequence of subprocesses TP and which is performed by the user.

Hereinafter, in an abridgement, “the desired value” is also used instead of “the at least one desired state SZ and/or the at least one desired action SA or the at least one desired correction state SKZ and/or the at least one desired correction action SKA”. The desired value therefore denotes at least one of the actions and/or one of the states which are intended to be performed and/or attained when one of the subprocesses TP or one of the correction subprocesses KTP is performed.

In various exemplary embodiments, in the comparator 16, for example, the action and/or the state detected by means of the sensor 14 can be linked to the subprocess TP which is respectively to be performed and concerning which the information was provided by means of the at least one actuator 12.

In various exemplary embodiments, the comparator 16 can be designed to compare the information provided by the sensor 14 directly with the desired value. To put it another way, the information provided by the sensor 14 can be suitable for being compared directly with the desired value. By way of example, the state detected by the sensor 14 and/or the action detected by the sensor 14 can be detected and provided such that said state and/or said action are/is the information provided, which can be compared with the desired value directly, i.e. without further processing.

By way of example, the sensor 14 can comprise a temperature sensor 14 which assigns a numerical value for a detected state, e.g. a component which is arranged in the work area and has a temperature, and provides said numerical value, in this case for example the temperature of the component. The temperature can be provided by the temperature sensor 14 in degrees Celsius or some other unit of temperature if the temperature sensor is calibrated, or the temperature can be provided in the form of a raw data value. The information provided for the comparator 16 by the temperature sensor 14 can therefore be for example a calibrated numerical value which corresponds to the temperature, or an uncalibrated numerical value which is unambiguously assignable to the temperature of the component. The comparator 16 can be designed to compare the numerical value provided with the desired value. In this example, the desired value provided by the processor 10 can be a numerical value which corresponds to a desired temperature. The numerical value can be compared by the comparator 16 with the temperature value provided by the temperature sensor 14. If the temperature sensor 14 provides the temperature in the unit of temperature, the desired temperature provided by the processor 10 can be present in the same unit of temperature. If the temperature sensor 14 provides the temperature as the uncalibrated numerical value, the desired temperature provided by the processor 10 can be provided by the processor 10 as a desired numerical value coordinated with the temperature sensor 14, wherein the desired numerical value can correspond to the value about which it is known, for example on the basis of a calibration table, that it is provided by the temperature sensor 14 in the event of the desired temperature being detected.

In various exemplary embodiments, the comparator 16 can be designed, for example, to process the information provided by the sensor 14. By way of example, the comparator 16 can be designed to carry out operations, for example computational operations, on or with the information provided.

In various exemplary embodiments, the comparator 16 can be designed to compare the information provided by the sensor 14 with the desired value indirectly. To put it another way, the information provided by the sensor 14 can be suitable for being compared with the desired value indirectly, i.e. only after processing of the information provided by the sensor 14. By way of example, the state detected by the sensor 14 and/or the action detected by the sensor 14 can be detected and provided such that the information provided must first be processed, for example by the comparator 16, before it can be compared with the desired value.

In the above exemplary embodiment with the uncalibrated numerical value which is provided by the temperature sensor 14 and which is unambiguously assignable to the temperature of the component, the comparator 16 can be designed to perform a calibration of the uncalibrated numerical value, for example on the basis of a calibration table stored in the comparator 16, and thus to process the numerical value provided by the sensor 14 and to convert it into a temperature value in a unit of temperature. The temperature value generated from the numerical value provided by the sensor 14 by the comparator 16 by means of the processing can then be compared with the desired value, which in this case is also present as a numerical value with a unit of temperature, by the comparator 16.

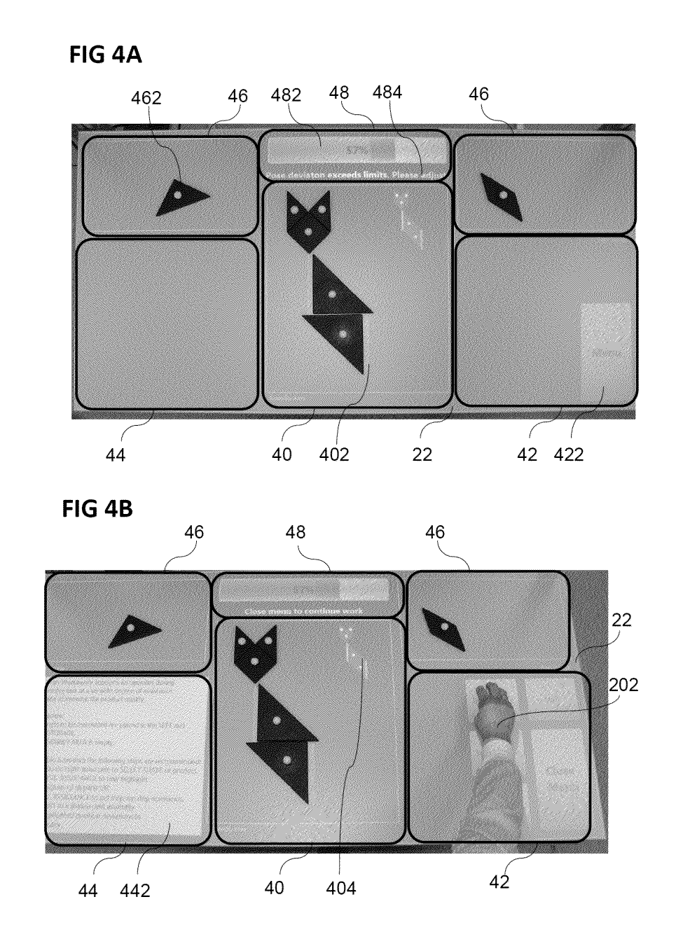

Further exemplary embodiments in which information provided by the sensor 14 can be compared with a desired value directly or indirectly are illustrated for example in FIGS. 4A and 4B, FIGS. 5A to 5D, FIGS. 6A to 6H, and FIGS. 7A to 7C.

In various exemplary embodiments, the comparator 16 can be designed to process two-dimensional images, for example to subtract two images from one another. At least one of the images can be provided for example by the sensor 14, for example by a camera 14, for example by a camera 14 which generates two-dimensional images in the visual spectral range and provides them for the comparator 16.

The camera 14 can provide two images, for example, of which one was recorded before an action was performed, and the other after the performance of the action. The comparator 16 can subtract the image which was recorded before the action from the image which was recorded after the action and, on the basis thereof, can detect what was brought about by the action, and thus deduce the action. The action deduced can then be compared by the comparator 16 with the at least one desired action SA which was provided for the comparator 16 by the processor 10. If the comparison reveals that the action exactly corresponds to the desired action SA, the comparator 16 can arrive at the result that the action corresponds to the desired action SA. If the comparison of the state after the action with the desired state SZ reveals that the state exactly corresponds to the desired state SZ, the comparator 16 can arrive at the result that the state corresponds to the desired state SZ. If the comparison reveals that the action deviates from the desired action SA, the comparator 16 can arrive at the result that the action does not correspond to the desired action SA. If the comparison reveals that the state deviates from the desired state SZ, the comparator 16 can arrive at the result that the state does not correspond to the desired state SZ.

In various exemplary embodiments, the processor 10 can provide the comparator 16 with the tolerance range of the desired action SA in addition to the desired action SA and/or the tolerance range of the desired state SZ in addition to the desired state SZ.

In various exemplary embodiments, the comparator 16 can compare the information provided by the sensor 14 not only with the at least one desired action SA and/or with the at least one desired state SZ, but with the tolerance range assigned to the desired action SA and/or with the tolerance range assigned to the desired state SZ. If the comparison reveals that the action corresponds to the desired action SA to such an extent, or deviates from the desired action SA so little, that the action lies in the tolerance range of the desired action SA, the comparator 16 can arrive at the result that the action corresponds to the desired action SA. If the comparison reveals that the state corresponds to the desired state SZ to such an extent, or deviates from the desired state SZ so little, that the state lies in the tolerance range of the desired state SZ, the comparator 16 can arrive at the result that the state corresponds to the desired state SZ. If the comparison reveals that the action deviates from the desired action SA to such an extent that the action does not lie within the tolerance range of the desired action SA, the comparator 16 can arrive at the result that the action does not correspond to the desired action SA. If the comparison reveals that the state deviates from the desired state SZ to such an extent that the state does not lie within the tolerance range of the desired state SZ, the comparator 16 can arrive at the result that the state does not correspond to the desired state SZ.

In various exemplary embodiments, the comparator 16 can be designed to check at least one condition for selecting one of the assigned correction subprocesses KTP as selected correction subprocess KTP. By way of example, the comparator 16 can compare the state and/or the action determined by the comparator on the basis of the information provided by the sensor 14 with the condition which is assigned to the correction subprocess KTP. In the example from FIG. 1B, the comparator 16 can be designed to compare the determined state, the determined action and/or a linkage of state and action for example with a condition B1-1. If the comparison reveals that the condition B1-1 is met, the comparator 16 can provide the processor 10 with this result, and the processor 10 can provide the correction subprocess KTP to which the condition B1-1 is assigned, in this example KTP1-1, as correction subprocess KTP1-1 to be performed. If the comparator 16 arrives at a result that the condition B1-1 is not met, the comparator 16 can be designed to compare the determined state, the determined action and/or a linkage of state and action for example with a condition B1-2, etc.

In various exemplary embodiments, the comparator 16 can be designed to compare all conditions B with the determined state, the determined action or the linkage thereof and then to provide the processor 10 with the result.

In various exemplary embodiments, the comparator 16 can be designed to check the conditions B only if none of the desired states SZ and/or none of the desired actions SA which are assigned to the currently performed TP are/is fulfilled.

In various exemplary embodiments, the comparator 16 can provide the processor 10 with the result of the comparison of the present state and/or of the determined action with the at least one desired state SZ, the at least one desired action SA, the at least one desired correction state SKZ, the at least one desired correction action SKA and/or the condition B.

This is indicated in FIG. 1B by a connection 17 which, by means of arrows facing in the direction of dashed frames around the desired states, the desired actions, the desired correction states SKZ, the desired correction actions SKA and the conditions B, is intended to illustrate that the comparator 16 provides the processor 10 with the result of the comparison of action/state with desired (correction) action/state and/or condition. The comparator 16 can provide the processor 10 for example with the result that the action whose performance is deduced by the comparator 16 on the basis of the information provided by the sensor 14 does not correspond to the desired action SA. The comparator 16 can provide the processor 10 for example with the result that the action whose performance is deduced by the comparator 16 on the basis of the information provided by the sensor 14 corresponds to the desired action SA. The comparator 16 can provide the processor 10 for example with the result that the state determined by the comparator 16 on the basis of the information provided by the sensor 14 does not correspond to the desired state SZ. The comparator 16 can provide the processor 10 for example with the result that the state determined by the comparator 16 on the basis of the information provided by the sensor 14 corresponds to the desired state SZ.

In various exemplary embodiments, the actuator 12 can be designed to provide information, which is presented to the user, about the individual subprocesses TP of the process that are to be performed in accordance with the indication provided by the processor 10. To put it another way, the processor 10 can provide an indication about the individual subprocesses to be performed, for example about the next subprocess to be performed, for the actuator 12, and the actuator 12 can present the information to the user. In FIG. 1A and FIG. 1B, that is symbolized on the basis of the connection 11 between the processor 10 and the actuator 12. In FIG. 1B, by way of example, symbols for a plurality of the subprocesses TP and of the desired states SZ and of the desired actions SA are illustrated with thicker borders than the others, and the connection 11 to the actuator 12 is provided with a frame illustrated with a thick line. This is intended to illustrate that, in various exemplary embodiments, from the subprocesses TP the subprocesses TP to be performed can be selected in order to be presented to the user by means of the actuator.

In various exemplary embodiments, all the subprocesses TP to be performed can be presented to the user. The subprocess to be performed can be identified as subprocess TP to be performed by means of highlighting, for example.

In various exemplary embodiments, the information about the subprocess TP to be performed can be presented to the user by a desired action SA and/or a desired state SZ to be attained being presented.

In various exemplary embodiments, the explanations with regard to presenting the information provided by the processor 10 about the individual subprocesses TP of the process that are to be performed can likewise apply to presenting information provided by the processor 10 about individual correction subprocesses KTP that are to be performed.

In various exemplary embodiments, the actuator 12 can present to the user visually, for example, the information about the subprocesses TP that are to be performed. The actuator 12 can comprise a visualization system 12, for example.

The actuator 12 can comprise a monitor 12, for example. In various exemplary embodiments, the monitor 12 can present to the user for example the predefined sequence of subprocesses of a process, said sequence being provided by the processor 10, or a plurality of subprocesses of the predefined sequence of subprocesses. The subsequent subprocess of the predefined sequence of subprocesses TP can be highlighted visually, for example by means of a larger script, by means of a different color than the other subprocesses, or the like.

The monitor 12 can present the predefined sequence of subprocesses for example in text form, in the form of symbols, as video sequences which show an action to be carried out, or the like.

In various exemplary embodiments, the monitor 12 can present to the user just the subsequent subprocess TP of the predefined sequence of subprocesses TP, for example as text, symbol, video, or the like.

In various exemplary embodiments, the actuator 12 can comprise a projector 12. The projector 12 can be designed for example such that it projects into a work area of the user.

In various exemplary embodiments, the actuator 12 can be designed such that it projects position information, text information, color information, or the like into the work area of the user.

In various exemplary embodiments, the projector 12 can project a brightness distribution, for example into the work area of the user, which brightness distribution highlights a part which is to be dealt with next or a position in which a part to be arranged next should be arranged (in this respect, see e.g. FIG. 6F or FIG. 6A).

In various exemplary embodiments, the projector 12 can present detailed information concerning a subprocess TP to be performed as text in the work area of the user, symbolize work progress by means of a bar filling up (progress bar) (see e.g. FIG. 4B), etc.

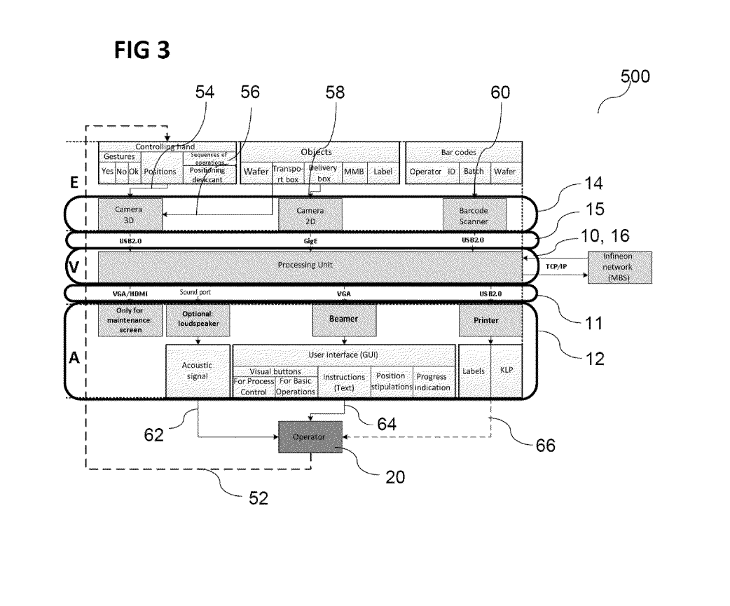

In various exemplary embodiments, the projector 12 can project a virtual menu which is operable by the user for example by means of hand gestures which can be detected by the sensor 14. To put it another way, the projector 12 can project a menu, and the user can position a hand such that the hand position is detected by the sensor 14. Depending on the chosen menu item (see, for example, FIG. 3 for an explanation of the information which is exchanged between processor 10, sensor 14, comparator 16 and actuator 12 when the virtual menu is operated and one of the menu items is chosen, for example), more extensive information can be provided by means of the projector 12.

In various exemplary embodiments, the actuator 12 can comprise a so-called “head-up display”. In the case of a head-up display, the information is projected into the user's field of view, for example onto a transparent or predominantly transparent surface, such that the user need not change his/her viewing direction in order to detect the projected information. By way of example, between the user and the work area there can be arranged a predominantly transparent projection surface which does not restrict the user's view of the work area, but affords a possibility of projecting thereon information about the subprocesses TP to be performed, for example—as explained on the basis of the projector—by means of the highlighting of the part to be processed or the target position.

In various exemplary embodiments, the actuator 12 can comprise electronic spectacles (also designated as monitor spectacles). The electronic spectacles can enable a function similar to the head-up display, i.e. insertion of the information regarding the subprocesses to be performed into the user's field of view. Furthermore, the electronic spectacles 12 can be designed to detect the viewing direction and/or the field of view of the user and to adapt the projected information and/or a positioning of the projected information by the electronic spectacles 12 thereto.

In various exemplary embodiments, the actuator 12 can comprise a loudspeaker 12. The loudspeaker 12 can be designed for example such that it supplies the user with audible information about the subprocesses TP to be performed. By way of example, the loudspeaker 12 can provide audible instructions as to how the subprocess TP is to be performed, and/or the loudspeaker 12 can emit an acoustic warning signal if the subprocess TP to be performed was performed erroneously.

In various exemplary embodiments, the actuator 12 can comprise a mechanical information system 12. The mechanical information system 12 can be designed such that it presents information about the subprocesses to be performed to the user in a mechanical manner. The mechanical information system 12 can comprise for example a system for generating information for haptic detection, for example Braille. By way of example, information as to how the subprocess to be performed should be performed can be presented to the user by means of a Braille generator 12. Another example of a mechanical information system may be a vibration generator 12, for example. The vibration generator 12 can emit a mechanical signal to the user, for example, by means of vibration, if a subprocess TP was performed erroneously. A further example of a mechanical information system may be a robot arm 12. The robot arm 12 can be designed for example to provide a specific object for processing in the next subprocess TP, and thus to provide the information about what part is to be processed next. The robot arm 12 can be embodied for example as displacement means, e.g. for automatic, for example coarse, positioning of the object to be processed.

In various exemplary embodiments, the actuator 12 can comprise any other device suitable for presenting to the user the information about the individual subprocesses TP of the process that are to be performed in accordance with the indication provided by the processor 10.

In various exemplary embodiments, the actuator 12 can furthermore be designed to reproduce the information detected by the sensor 14 or a portion of the information detected by the sensor 14. By way of example, the loudspeaker 12 can acoustically reproduce information which was read out from an RFID transponder by means of an RFID sensor 14, or the projector 12 or the monitor 12 can be designed to visually present the information detected by a bar code sensor 14.

In various exemplary embodiments, the actuator 12, insofar as technically possible, can comprise a combination of the described examples for the actuator 12. By way of example, the actuator 12 can comprise both a projector 12, which highlights the position of the next part to be positioned, and a monitor 12 for explaining the subprocess TP to be performed and/or a lamp 12 and/or a loudspeaker 12 for signaling an erroneously performed action.

FIG. 2A is a schematic illustration of a process support system 300 in accordance with various exemplary embodiments. The process support system 300 is illustrated as a frontal view on the left and as a side view on the right.

In various exemplary embodiments, the process support system 300 can comprise a processor 10 and a comparator 16. These can be part of a computer 30.

In various exemplary embodiments, the process support system 300 can comprise a table 22. A work area of a user 20 can be arranged on the table 22.

In various exemplary embodiments, the process support system 300 can furthermore comprise an actuator 12, for example a projector 12a. The projector 12a can be arranged at a height situated above the table 22. The projector 12a can be arranged above the table 22, for example above the work area of the user 20. A distance between the projector 12a and an upper surface of the table can be chosen such that a projection of the projector 12a can be focused. The projector 12a can be arranged such that it can project perpendicularly downward, such that its projection is subject to a minimum distortion. The projector 12a can also be arranged such that its projection, for example upon impinging on an upper surface of the table 22, would be subjected to a distortion. The distortion can be compensated for by means of adaptations at the projector 12a.

In various exemplary embodiments, the projector 22 can be arranged and/or designed such that it can project onto the entire upper surface of the table 22. The projector 12a can be arranged and/or designed such that it projects only onto a partial area of the table 22, for example onto the work area.

In various exemplary embodiments, the process support system 300 can comprise a plurality of projectors 12a. The plurality of projectors 12a can be arranged and/or designed for example such that each of them projects onto a partial area of the upper surface of the table 22, wherein the partial areas can be arranged such that they supplement one another, for example overlap at most partly.

In various exemplary embodiments, the projector 12a can be used for providing information which is presented to the user 20. The information can comprise for example the individual subprocesses TP of the process that are to be performed in accordance with the indication provided by the processor 10. See FIGS. 4 to 8A for examples of the information which can be provided to the user by means of the projector 12a.

In various exemplary embodiments, the process support system 300 can comprise a monitor 12b. The monitor 12b can be fitted at a height situated above the upper surface of the table 22. The monitor 12b can be arranged behind the table 22, as viewed from the user 20. The monitor 12b can be arranged behind the work area, for example, as viewed from the user 20. This makes it possible that the user 20 need only look up from the work area in order to detect information presented on the monitor 12b.

In various exemplary embodiments, the monitor 12b can be provided with a touch-sensitive display configured such that an input by the user 20 can be effected by means of the touch-sensitive display. The monitor 12b can be arranged such that the user can comfortably reach the display of the monitor 12b, for example to a left or right of the user.

In various exemplary embodiments, the monitor 12b can be used for providing information that is presented to the user 20. The information can comprise for example the individual subprocesses TP of the process that are to be performed in accordance with the indication provided by the processor 10. See FIG. 5A for an example of the information which can be presented to the user by means of the monitor 12b.

In various exemplary embodiments, the process support system 300 can comprise a sensor 14, for example a 2D camera 14a (for short: camera). The camera 14a can be arranged at a height situated above the upper surface of the table 22. The camera 14a can be arranged substantially at the same height as the projector 12a. The camera 14a and the projector 12a can be mounted on a common mount 24, for example. The camera 14a and the projector 12a can also be fitted at different heights and/or on different mounts 24. A distance between the camera 14a and the upper surface of the table 22 can be chosen such that the camera 14a can generate a sharp imaging of the upper surface of the table 22.

In various exemplary embodiments, the camera 14a can be designed such that it detects the entire upper surface of the table 22. In various exemplary embodiments, the camera 14a can be designed such that it detects only a portion of the upper surface of the table 22. The camera 14a can be designed for example such that it detects the work area. The camera 14a can detect for example objects and/or for example hands 202 of the user 20 that are arranged in the work area.

In various exemplary embodiments, the process support system 300 can comprise a plurality of cameras 14a. The cameras 14a can be arranged at different positions. The different positions can be situated for example above the upper surface of the table 22. The cameras 14a can be arranged and/or designed for example such that each of them detects a partial area of the upper surface of the table 22, wherein the partial areas can be arranged such that they supplement one another, for example overlap at most partly. The cameras 14a can be arranged and/or designed for example such that each of them images a substantially identical area, but from different directions. The cameras 14a can be arranged, for example, as illustrated in FIG. 2A (left), above opposite ends of the table 22, such that the work area is arranged below and between them on the upper surface of the table 22. This can make it possible for the work area to be imaged almost completely, even if for example the hand 202 of the user 20 is situated in the work area, since a portion of an area which is concealed by the hand 202 of the user 20 as viewed from one camera 14a is not concealed by the user's hand as viewed from the other camera 14a, and vice versa.

In various exemplary embodiments, the process support system 300 can comprise a connection 11. The connection 11 can connect the processor 10 to the actuator 12, for example to the projector 12a and/or to the monitor 12b. The connection 11 can comprise any type of connection 11 suitable for providing the projector 12a and/or the monitor 12b with information provided by the processor 10, which information can be for example electronic data, for example concerning the subprocesses to be performed. The connection 11 can comprise a data cable 11, for example.

In various exemplary embodiments, the connection 11 can be used to provide the projector 12a and/or the monitor 12b with the information provided by the processor 10. To put it another way, the processor 10 can provide the projector 12a and/or the monitor 12b with the information by means of the connection 11.

In various exemplary embodiments, the connection 11 can be connected to the processor 10 and to the projector 12a and/or the monitor 12b by means of suitable terminals such that the provision of the information from the processor 10 to the projector 12a and/or to the monitor 12b is made possible.

In various exemplary embodiments, the process support system 300 can comprise a connection 15. The connection 15 can connect the comparator 16 to the sensor 14, for example to the camera 14a. The connection 15 can comprise any type of connection 15 suitable for providing the comparator 16 with information provided by the camera 14a, which information can be for example electronic data, for example concerning an action carried out and/or a present state. The connection 15 can comprise a data cable 15, for example.

In various exemplary embodiments, the connection 15 can be used to provide the comparator 16 with the information provided by the camera 14a. To put it another way, the camera 14a can provide the comparator 16 with the information by means of the connection 15.

In various exemplary embodiments, the connection 15 can be connected by means of suitable terminals at the camera 14a and at the comparator 16 such that the provision of the information from the camera 14a to the comparator 16 is made possible.

In various exemplary embodiments, the process support system 300 can comprise a connection 13. The connection 13 can connect the comparator 16 to the processor 10. The connection 13 can comprise any type of connection 13 suitable for providing the comparator 16 with information provided by the processor 10, which information can be for example electronic data, for example concerning a desired action, a desired state, a desired correction action, a desired correction state and/or a condition.

In various exemplary embodiments, the connection 13 can be used to provide the comparator 16 with the information provided by the processor 10. To put it another way, the processor 10 can provide the comparator 16 with the information by means of the connection 13.

In various exemplary embodiments, the connection 13 can be connected to the processor 10 and to the comparator 16 by means of suitable terminals such that the provision of the information from the processor 10 to the comparator 16 is made possible.

In various exemplary embodiments, the process support system 300 can comprise a connection 17. The connection 17 can connect the comparator 16 to the processor 10. The connection 17 can comprise a data cable 17, for example. The connection 17 can comprise any type of connection 17 suitable for providing the processor 10 with information provided by the comparator 16, which information can be for example electronic data, for example concerning presence or absence of the desired action, the desired state, the desired correction action, the desired correction state and/or the condition. The connection 17 can comprise a data cable 17, for example.

In various exemplary embodiments, the connection 17 can be used to provide the processor 10 with the information provided by the comparator 16. To put it another way, the comparator 16 can provide the processor 10 with the information by means of the connection 17.

In various exemplary embodiments, the connection 17 can be connected to the processor 10 and to the comparator 16 by means of suitable terminals such that the provision of the information from the comparator 16 to the processor 10 is made possible.

The connection 13 and the connection 17 are illustrated as two separate connections in FIGS. 1A and 1n FIG. 1B. However, in various exemplary embodiments, the separately illustrated connections 13 and 17 can form a single connection 13, 17.

The connection 13, 17 can comprise any type of connection 13, 17 suitable for exchanging information between the comparator 16 and the processor 10, which information can be for example electronic data, for example the data described above in association with the connection 13 and/or the connection 17. The connection 13, 17 can comprise a data cable 13, 17 for example. In various exemplary embodiments, the connection 13, 17 can consist in at least one part of the processor 10 being identical to at least one part of the comparator.

In various exemplary embodiments, the connection 13, 17 can be used to exchange the information provided by the processor 10 and/or by the comparator 16 between the comparator 16 and the processor 10. To put it another way, the processor 10 and the comparator 16 can exchange the information by means of the connection 13, 17.

In various exemplary embodiments, the connection 13, 17 can be connected to the processor 10 and to the comparator 16 by means of suitable terminals such that the exchange of the information between the comparator 16 and the processor 10 is made possible.

FIG. 2B shows a partial view of a process support system 301 in accordance with various exemplary embodiments.

In various exemplary embodiments, the process support system 301 can comprise a sensor 14, for example a 2D camera 14a, a 3D camera 14b and/or a bar code scanner 14c. The 2D camera 14a and/or the 3D camera 14b can be arranged for example such that an area detected by them/it, in the case of cameras this can correspond to a (sharply) imaged area, lies at least partly in a work area designed for performing processes and/or subprocesses. The 2D camera 14a and/or the 3D camera 14b can be mounted for example on a mount 24 above a table 22 such that the area detected by it/them lies below it/them, for example perpendicularly below it/them, on the table 22 in the work area. If the process support system 301 comprises a plurality of cameras 14, for example a 2D camera and a 3D camera, as illustrated in FIG. 2B, these can be arranged for example alongside one another and approximately at the same height above the work area. However, the plurality of cameras 14 can also be arranged at a distance and/or at different heights above the work area.

In various exemplary embodiments, the camera(s) 14a, 14b can be used to detect actions carried out by the user 20 and/or the states attained as a result, as explained in connection with FIGS. 1A, 1B and 2A.

In various exemplary embodiments, the bar code scanner 14c can be arranged such that the user 20 illustrated in FIG. 2A can easily reach it with his/her hands 202. This enables the user 20 to bring a part for detecting a bar code into a detection region of the bar code scanner 14c. The bar code scanner 14c can be arranged for example such that inadvertent scanning of the bar code of the part is not possible, for example by virtue of the detection region of the bar code scanner 14c lying outside an action region in which the user 20 performs a main action. A main action can be an action which visibly advances a process, for example mounting or demounting of a part, whereas an auxiliary action can be an action which supports the main action or the process, for example selection of the process to be performed, removal of the next part to be arranged from a supply area and/or the detection of information about the part by means of the bar code scanner 14c.

In various exemplary embodiments, information retrievable for each of a plurality of parts by means of the bar code scanner 14c, and a succession of subprocesses (to put it another way, an assembly specification for the plurality of parts) can be designed such that incorrect mounting is precluded if the correct parts (i.e. the parts detected by means of the bar code and confirmed to be correct) are selected and mounted.

In various exemplary embodiments, instead of the bar code scanner 14c, it is also possible to use some other system for individually identifying and detecting parts, for example an RFID transponder and an RFID sensor 14.

In various exemplary embodiments, the process support system 301 can comprise an actuator 12, for example a projector 12a and/or a monitor 12b.

In various exemplary embodiments, the projector 12a can be arranged above the work area, for example, as explained in association with FIG. 2A, for example perpendicularly above the work area. The projector 12a can be mounted for example on the mount 24, for example alongside the camera 14a and/or alongside the camera 14b. As illustrated in FIG. 2B, the projector 12a can be arranged at a different height above the work area than the camera(s) 14a and/or 14b.

In various exemplary embodiments, the projector 12a can be mounted at the same height as the camera(s) 14a and/or 14b and/or at a distance therefrom.

In various exemplary embodiments, the projector 12a can be used to provide the user with information about subprocesses, as explained in association with FIGS. 1A, 1B and 2A.

In various exemplary embodiments, the monitor 12b can be arranged such that information provided to the user 20 thereon, for example about subprocesses and/or correction subprocesses to be performed, can easily be detected, for example by the user 20 having to look up from the work area only a little, as explained above in association with FIG. 2A.

In various exemplary embodiments, the process support system 301 can be used to support a process, as described in association with FIGS. 1A, 1B and 2A, for example by virtue of the fact that the 2D camera 14a and the 3D camera 14b detect the actions performed by the user 20 and/or the states attained by the actions and the projector 12a and the monitor 12b provide the user with information about subprocesses to be performed or about assigned desired actions and/or about assigned desired states to be attained.

FIG. 2C shows a schematic illustration of a process support system 400 in accordance with various exemplary embodiments. In particular, information flows which occur during use of the process support system 400 in the event of a process being performed by a user 20 are illustrated symbolically.

In various exemplary embodiments, the process support system 400 can comprise an actuator 12, a sensor 14, a table 22, a mount 24, on which the actuator 12 and the sensor 14 are mounted, and a robot system 32. Furthermore, the process support system 400 can comprise a processor 10 and a comparator 16, which can form parts of a production control system (also referred to as “manufacturing execution system”, MES for short).

The process support system 400 can correspond to the figures explained in association with FIGS. 1A, 1B, 2A and 2B and can be designed to support processes explained in association with said figures.

In various exemplary embodiments, the user (designated as “Operator” in FIG. 2C) can perform actions and bring about states by means of the actions. This is designated as “Haptic, visual stipulations” in FIG. 2C.

In various exemplary embodiments, the sensor 14 can detect the stipulations and forward what has been detected to the comparator 16, which can be part of the production control system (MES). This is designated by “Work progress” in FIG. 2C. The comparator 16 can be designed such that it determines the work progress by comparison and forwards it to the processor 10, which can also be part of the production control system. The processor 10 can provide a next subprocess to be performed, for example for the actuator 12 and/or the robot system. This is designated as “Formulations, processes” in FIG. 2C.

In various exemplary embodiments, communication of the information—designated as “Haptic, visual information return flow”—from the process support system 400 to the user 20 can take place, for example by means of information provided by the actuator 12, or by means of an action performed by the robot system.

FIG. 3 shows a signal flow chart 500 of a process support system in accordance with various exemplary embodiments. The term “signal flow chart” can be interpreted broadly in this context since a flowing signal here for example is also taken to mean the, e.g. mechanical, signal which the user 20 exerts on the object and/or on other things by means of an, e.g. mechanical, action 52 and which is then detected by a sensor 14, for example as a, for example electromagnetic, successor signal 54, 56, 58, 60, for example as light.

The process support system can be embodied for example in accordance with one of the exemplary embodiments described in association with FIGS. 1A to 2C.

In various exemplary embodiments, the process support system can comprise a processor 10 and a comparator 16. The processor 10 and the comparator 16 can both be part of a processing unit 10, 16. The processing unit 10, 16 can be connected to a network, for example by a TCP/IP interface.

In various exemplary embodiments, the process support system can comprise an actuator 12. The actuator 12 can comprise for example a screen, a loudspeaker, a projector (beamer) and/or a printer. The screen can be used, for example, to display information during maintenance of the process support system. The loudspeaker can be suitable, for example, for outputting an acoustic signal. The projector can be suitable, for example, for generating a virtual user interface (also designated as GUI, standing for “Graphical User Interface”). The virtual user interface can comprise for example visual switches, also designated as buttons. The visual switches can be effective for example at a basic operating level or process controlling level. The user interface can furthermore comprise instructions, for example text instructions. The user interface can furthermore comprise a progress indicator. The user interface can furthermore comprise position stipulations. The printer can be suitable, for example, for printing out a bar code, an address sticker or other marking, also designated as label, and/or a cost-performance plan.

In various exemplary embodiments, the processor 10 (the processing unit 10, 16) can be connected to the actuator 12 by means of a connection 11. The connection 11 can comprise for example a VGA/HDMI port, a VGA port, a USB port and/or a sound port.

In various exemplary embodiments, the user can detect information presented by the actuator 12, which information was provided for the actuator 12 by the processor 10 by means of the connection 11, for example as acoustic information 62 (also designated as acoustic signal 62), as visual information 64 (also designated as visual signal 64) and/or as haptic/manual information 66 (also designated as haptic signal 66 and/or as manual signal 66).

In various exemplary embodiments, the process support system can comprise a sensor 14. The sensor 14 can comprise for example a 2D camera, a 3D camera and/or a bar code scanner. The sensor 14 can detect an action performed by the user 20 and/or a state brought about by means of the action performed, for example by means of the signals 54, 56, 58, 60 described above. The action performed by the user 20 can comprise for example gesticulating with a controlling hand, positioning the object in a transport box, removing an object from a delivery box, presenting a bar code, assigned for example to a wafer, a user or a batch, positioning a desiccant in a transport box, etc. States attained as a result of the action performed by the user 20 can comprise for example a hand positioned at a specific location of a virtual menu, an object, for example a wafer, arranged in a transport box or a delivery box, a marking (e.g. a label, a sticker, an address tag) fitted at a predetermined location, etc.

In various exemplary embodiments, the sensor 14 can provide the comparator 16, i.e. the processing unit 10, 16, with the information about the action performed and/or about the attained state by means of a connection 15. The connection 15 can comprise for example a USB port, e.g. a USB 2.0 port, and/or a GigE port.

FIG. 4A and FIG. 4B show a work area of a process support system for processing an object in accordance with various exemplary embodiments during performance of a process with support by the process support system.

In various exemplary embodiments, the work area illustrated can be arranged for example on the table 22 illustrated in FIG. 2A. In various exemplary embodiments, the process support system can be the process support system illustrated in FIG. 2A.

In various exemplary embodiments, the work area can comprise an action area 40. The action area 40 can be the area of the work area which is provided for the user to perform there an envisaged sequence of subprocesses TP for processing an object. The action area 40 can be configured as a virtual action area 40, to put it another way as a virtually delimited action area 40. The action area can comprise a device for processing the object, for example a holding device or a positioning device.

Nevertheless, in various exemplary embodiments, the user can also perform actions outside the action area 40.

As is illustrated in FIG. 4A and in FIG. 4B, in various exemplary embodiments, a plurality of parts 462 can be arranged in the action area 40. The plurality of parts 462 can form jointly, for example, the object to be processed. Information about a current status 404 can be arranged in the action area 40. The information about the current status 404 can provide for example a current state and/or a desired state. In FIG. 4A and FIG. 4B, by way of example, by means of a projector 12, the position of the parts 462 that is detected by means of a sensor 14, for example by means of a camera 14, is introduced symbolically as current state, and, as information concerning the desired state provided by means of the processor 10, a white area is projected where the parts 462 should actually be positioned.

In various exemplary embodiments, for example if the user 20 requires both hands 202 for processing the object, the action area 40 can be arranged in a position of the work area which can be reached the most easily by both hands 202 of the user 20.

In various exemplary embodiments, for example if the user 20 requires only one hand 202 for processing the object, the action area 40 can be arranged in a position of the work area which can be reached the most easily by that hand 202 of the user 20 which is preferred for processing the object.

In various exemplary embodiments, the work area can comprise a menu area 42. At least one menu item 422 can be projected into the menu area 42 by means of the projector 12.

In various exemplary embodiments, the at least one menu item 422 projected into the menu area 42 can serve as a virtual menu. To put it another way, the menu can be operated for example by the user 20 positioning his/her hand 202 such that a sensor 14, for example a camera 14, can detect the position of the hand 202 of the user 20 and the position of the hand can be assigned to the projected menu item 422 or to one of the plurality of projected menu items 422. The operation of the virtual menu can be a subprocess of the process for processing the object; by way of example, the menu can be used to select a choice between different processing possibilities for the object, to select an abundance of detail for information presented to the user, etc.

In various exemplary embodiments, a comparator 16 can be designed such that it compares the position of the hand 202 that is detected by the camera 14 with a desired state SZ or a plurality of desired states SZ for the subprocess “Operating the virtual menu”. The comparator 16 can provide the processor 10 with a result of the comparison. On the basis of the result, the processor 10 can provide the projector 12 and the comparator 16 with a subsequent subprocess TP, for example introduction of further menu items, which are introduced in the menu area 42 for example in FIG. 4B, and/or provision of additional information, as is illustrated in FIG. 4B for a first information area 44 on the basis of the text information window 442. Alternatively, the processor 10 can provide the projector 12 and the comparator 16 with a correction subprocess KTP, for example (for the case where the hand is/was positioned in an area of the menu area which cannot be assigned to a currently selectable menu item 422) providing information “Position your hand over one of the menu items”, for example in the menu area 42 and/or in the information area 44.

In various exemplary embodiments, the work area can comprise one or a plurality of information areas 44, 48, for example the first information area 44 and/or the second information area 48. The information areas can be used, for example, to make accessible to the user 20 directly in the user's work area information provided by the processor 10 for example by means of the projector 12, for example by means of—projected into the information area or into one of the information areas 44, 48—a text 442, 484, a video, an explanatory graphic, for example a progress bar 482, or the like.

In various exemplary embodiments, the work area can comprise at least one storage area 46. The storage area 46 can be used to accommodate parts 462. The storage area 46 can be embodied as a virtual area 46, to put it another way as a virtually delimited area 46. The storage area 46 can be embodied as a storage container 46, for example a box without a lid.

The sensor 14, for example the camera 14, can be designed to detect the storage area 46. The sensor 14 can be designed for example to detect the parts 462 in the storage area 46.

The actuator 12, for example the projector 12, can be designed to present information provided by the processor 10 to the user in the storage area 46. By way of example, the projector 12 can identify the next part to be arranged for the user by means of projecting a highlighting, for example a bright or colored and/or moving frame.

FIG. 5A, FIG. 5B, FIG. 5C and FIG. 5D show a work area during processing of an object, wherein a method for supporting a process for processing the object in accordance with various exemplary embodiments is performed.

In various exemplary embodiments, the method can be performed by means of a process support system, wherein the process support system corresponds wholly or partly to one or a plurality of the process support systems explained in association with the preceding figures.

In various exemplary embodiments, the process support system can comprise, as illustrated in FIG. 5A, a table 22, on which a work area is arranged. Above the table 22, at a rear edge of the table as viewed from a user 20, a monitor 12 can be arranged in a manner facing the user. The monitor 12 can be arranged such that the user who performs an action in the work area need change his/her viewing direction only a little, for example by less than 90 degrees, for example less than 50 degrees, for example upward, in order to be able to detect information presented on the monitor.

In various exemplary embodiments, the work area arranged on the table, as illustrated in FIG. 5B, can comprise at least one action area 40, and also at least one menu area 42, at least one storage area 46, at least one first information area 44 and at least one second information area 48.

In various exemplary embodiments, a plurality of parts 462 can be arranged in the storage area 46. The plurality of parts 462 can form jointly, for example, the object to be processed. The process can comprise for example assembling the parts 462 to form an object. A selection of the object to be assembled is illustrated by way of example in FIG. 5A. The user uses a virtual menu 422 arranged in the menu area 42 in order to select from two possible objects to be assembled (in this case an image of a waiter and—hidden beneath the user's hand—an image of a cat) the desired object (the cat).

In various exemplary embodiments, the process support system can comprise a projector (not illustrated here) for presenting the information in the work area, e.g. the virtual menu and/or the further representations to be explained.

FIG. 5B illustrates that information about a subsequent subprocess can be provided for the user in the action area 40. By way of example, a subprocess to be performed can be illustrated by a superimposition of all the desired states assigned to the subprocess to be performed being represented. To put it another way, a processor 10 (not illustrated) of the process support system can provide a predefined sequence of subprocesses, and likewise for example the subprocess to be performed. However, a plurality of desired actions and/or desired states can be assigned to the subprocess to be performed. In the present example, the predefined sequence of subprocesses can comprise arranging the plurality of parts 462 in a specific order for forming the object in the shape of a cat, for example firstly arranging the part in the upper half of the body, then arranging the part in the lower half of the body, etc. In this example, however, the arrangement of none of the parts 462 relies on previous arrangement of a specific other part 462; to put it another way, the order in which the individual parts 462 are arranged is unimportant, in principle. Consequently, the desired actions assigned to a subprocess can comprise arranging all parts 462 that are still to be arranged, and/or the desired states assigned to the subprocess can comprise all correctly positioned parts still remaining. In FIG. 5B, the correct positions of all parts 462 still remaining are provided as information for the user 20 as light area 402. The subprocess to which these desired states are assigned can be for example arranging the part 462 in the lower half of the body.

In various exemplary embodiments, the displaying of all the desired states assigned to the subprocess to be performed can present information for the user 20 with a low degree of detailing. This degree of detailing can be chosen, for example, if the user has a great deal of experience with the process to be performed.

In various exemplary embodiments, for the user 20, on the monitor 12, for example, further information about the individual subprocesses to be performed can be provided; by way of example, a list of the subprocesses to be performed can be presented.

In various exemplary embodiments, work progress, for example in the form of a progress bar 482, can be displayed for the user 20 in the second information area 48. After the first part 462 of seven parts 462 has been arranged, the progress bar can indicate, for example graphically on the basis of a degree of filling of the bar and/or in the form of a numerical value, that 14% of the process has been effected. In FIG. 5C, the progress bar after two arranged parts 462 shows that 28% of the process has been effected, and in FIG. 5D the bar is completely filled and a text message informs the user “Shape accomplished”.

As is illustrated in FIG. 5C and in FIG. 5D, additional information can furthermore be provided for the user 20 in the first information area 44 and/or in the second information area 48. By way of example, the user 20 can be given information about particular current states or actions to be performed. In FIG. 5C, a text message “User in restricted area” is introduced for example in a partial area of the second information area 48. This information can serve for example as warning information for the user 20 to the effect that the user's body parts detected in the restricted area, for example in the action area 40, might conceal part of the information provided there, for example projected there. In FIG. 5D, a text message “Before restart, reset all objects” is introduced for example in the partial area of the second information area. This can present information about a concluding subprocess to be performed.

FIG. 6A to FIG. 6H show a work area during processing of an object, wherein a method for supporting a process for processing the object in accordance with various exemplary embodiments is performed.

In various exemplary embodiments, the method can be performed by means of a process support system, wherein the process support system can correspond wholly or partly to one or a plurality of the process support systems explained in association with the preceding figures.

In various exemplary embodiments, the process support system can substantially correspond to the process support system explained in association with FIG. 5A to FIG. 5D, and the method for supporting a process for processing the object can substantially correspond to the method explained in association with FIG. 5A to FIG. 5D, with an exception that a degree of detailing of the method illustrated in FIGS. 6A to 6H can be higher than the degree of detailing in the method illustrated in FIGS. 5A to 5D.

In various exemplary embodiments, a work area illustrated in FIG. 6A can comprise an action area 40, a menu area 42, two storage areas 46, a first information area 44 and a second information area 48. A plurality of parts 462 can be arranged in the storage areas 46, which parts are to be joined together to form an object within the action area 40. A virtual menu item 422 can be represented in the menu area 42. A projector (not illustrated) can be used for representing the menu item 422, highlightings, text messages 484, etc. Actions, states, etc. can be detected by at least one sensor (not illustrated), for example by a camera.

In various exemplary embodiments, information about a subprocess to be performed can be provided for the user 20, for example by means of marking or highlighting a part 462 to be arranged from the plurality of parts 462 to be arranged by means of a light contour 722 or a light projected area 722 superimposed on the part 462 to be arranged. The information about the subprocess to be performed can furthermore comprise information about a desired state assigned to the subprocess to be performed, for example by a target position being marked for the part 462 to be arranged, for example by means of a projection of a light area 724 onto the target position of the part 462 to be arranged. Furthermore, a text message 484 “Take highlighted object” can be displayed in the second information area. After the marked part 462 has been taken, said text message 484 can be changed, for example to “Place object in highlighted area”. Alternatively, it would also be possible, before the marked part 462 is taken, to mark only the part 462 to be taken, and to mark the target position only after the part has been taken. Simultaneously with the marking 722 of the part 462 to be taken, the text message 484 “Take highlighted object” can be displayed, for example in the second information area 48, and simultaneously with the marking 724 of the target position for the part 462 to be arranged, the text message 484 “Place object in highlighted area” can be displayed, for example in the second information area 48. Both possibilities are examples of a high degree of detailing of the information about the individual subprocesses to be performed, which information is provided for the user 20. This high degree of detailing can be chosen for example for training new users, for familiarizing an experienced user with a new process, and/or if desired by the user.

In various exemplary embodiments, it can be possible for a comparator (not illustrated), by means of a sensor which detects a performed action and/or an attained state and provides it/them for the comparator, to establish whether the desired action was performed and/or whether the desired state was attained. In the case where an action not corresponding to the desired action is performed, and/or in the case where a state not corresponding to the desired state is attained, the processor can provide the user 20 with a correction subprocess by means of the actuator, for example by means of the projector.

In various exemplary embodiments, the subprocess to be performed which is provided by the processor (not illustrated) can be assigned only the desired state provided for the user 20 by means of the information, for example by means of the markings 722, 724 and the text message 484, and/or the desired action provided. In FIG. 6A, correctly positioning the part marked by means of the marking 722 on the target position marked by means of the marking 724 is provided for example as desired action and/or desired state of a represented subprocess “arranging the right ear of the cat”, and only this desired action and this desired state are assigned to the subprocess “arranging the right ear of the cat” as desired state and/or desired action. Instead of the marked part 462, a different part 462 can be arranged correctly (in view of the object to be completed) at a different target position, for example the part 462 forming the upper half of the cat's body. The correct positioning of this part 462 is illustrated in FIG. 6E. The sensor can provide the comparator with information about the action carried out and/or about the state attained. The comparator can compare the action carried out and/or the state attained with the desired action and/or the desired state provided by the processor. Since, in this example, the subprocess is assigned only the correct positioning of the part for the right ear of the cat (for the sake of simplicity, taking the part and subsequently arranging the part are regarded here as one subprocess) as desired action and a correctly positioned part 462 at the position for the right ear, the comparator can provide for the processor as result of the comparison the fact that no desired action was carried out and no desired state was attained. Furthermore, the comparator can provide the processor with information about what incorrect action was carried out and/or what incorrect state was attained. The processor can thereupon provide the actuator with a correction subprocess.

In various exemplary embodiments, the subprocess to be performed which is provided by the processor, despite a representation of only one desired state and/or only one desired action, can be assigned a plurality of desired states and/or a plurality of desired actions. By way of example, for the subprocess “arranging the right ear of the cat” illustrated in FIG. 6A, for the user 20, as information about a desired action and/or desired state assigned to the subprocess to be performed, only the part 462 to be arranged can be marked in the storage area by means of the marking 722 and the target position can be marked by means of the marking 724 and the text message 484 “Take highlighted object” can be displayed in the second information area 48 (see FIG. 6A).

Nevertheless, the subprocess “arranging the right ear of the cat” can be assigned further desired states and/or further desired actions, for example a part 462 positioned correctly at the position for the upper half of the cat's body, a part 462 positioned correctly at the position for the left ear, taking a part 462 which is to be positioned in the upper half of the body, etc. A different desired action can be performed instead of the indicated desired action, and/or a different desired state can be attained instead of the indicated desired state. The sensor can detect the action carried out and/or the state attained and can provide the comparator with the information about that/those. The comparator can compare the action carried out and/or the state attained with the desired actions and/or desired states provided by the processor. Since the action carried out and/or the state attained correspond(s) to a non-indicated desired action and/or a non-indicated desired state, the comparator can provide for the processor as result of the comparison the fact that a desired action was carried out and/or a desired state was attained. Furthermore, the comparator can provide the processor with information about what desired action was carried out and/or what desired state was attained. The processor can thereupon provide the actuator with a subsequent subprocess instead of a correction subprocess (as in the preceding example).

FIG. 6C illustrates one example of the fact that a plurality of desired actions can be assigned to a subprocess to be performed. The subprocess to be performed “arranging the upper half of the body” can be assigned a desired action “correctly positioning the marked part at the marked target position”. The marked part 462 can be the part 462 marked by means of the marking 722 and arranged in the top left storage area 46; the target position can be marked by means of the marking 724 in the action area 40. Instead of taking the marked part 462, the user 20 can take an identically shaped part 462 arranged in the right storage area 46 (see FIG. 6B). This is illustrated in FIG. 6C. Despite taking the non-marked part 462, information concerning a correction subprocess to be performed is not provided for the user 20, since taking (and correctly positioning) the identically shaped part can be a further desired action assigned to the subprocess “arranging the upper half of the body”.

In various exemplary embodiments, as illustrated in FIG. 6D, performing an action which is not an assigned desired action and/or attaining a state which is not an assigned desired state of the subprocess performed can have the effect that the user 20 is provided with a correction subprocess. The correction subprocess can be provided for the user 20 by the processor by means of the actuator. In the example illustrated in FIG. 6D, the projector can be used to provide the correction subprocess, for example by means of a change in color of the marking 724 of the target position, by means of introducing a symbolic representation 404 of the erroneous state, for example in the action area 40, by means of a text message 484 (here: “Pose deviation exceeds limits. Please adjust”), which can be displayed in the second information area, for example, and/or by means of an error warning in the progress bar 482, for example by means of a different-colored marking 4822, for example in a signal color.

In various exemplary embodiments, the sensor can detect a correction action performed and/or a correction state attained. The sensor can provide the comparator with the detected correction action and/or the detected correction state. The comparator can compare the detected correction action and/or the detected correction state with one or a plurality of desired correction action(s) assigned to the correction subprocess and/or one or a plurality of desired state(s) assigned to the correction subprocess. The comparator can provide the processor with a result of the comparison. The comparator can provide the processor for example with the fact of whether the correction action performed corresponds to the desired correction action or one of the desired correction actions and/or whether the correction state attained corresponds to the desired correction state or one of the desired correction states. Furthermore, the comparator can provide the processor with information about what correction action was performed and/or what correction state was attained. The processor can provide for the user 20, on the basis of the information provided by the comparator, a subsequent subprocess or a further correction subprocess, which can be the correction subprocess already performed or a different correction subprocess.

In the example illustrated in FIG. 6E, the correction subprocess provided for the user can be “correcting the position of the arranged part”. After correction of the position of the part 462 by the user 20, the sensor, for example a camera, can provide the comparator with the corrected position of the part 462, if appropriate together with the positions of the previously arranged parts 462. The comparator can compare the provided position with the position provided by the sensor 10, for example by means of generating a difference image. The comparator can provide the processor with the information that all previously positioned parts are positioned correctly. Afterward, the processor can provide the actuator, e.g. the projector, with the information about the subsequent subprocess to be performed, and the projector can provide the user e.g. with the desired state assigned to the subprocess to be performed, for example by the target position being marked.

In various exemplary embodiments, performing a subprocess and/or a correction subprocess can necessitate auxiliary means, auxiliary positions, tools or the like, for example tools for mounting a part or for removing an incorrectly mounted part or detailed instructions as to how a correction is to be made. These can be indicated, marked or provided by means of the actuator.

FIG. 6F and FIG. 6G illustrate a further example of the fact that a subprocess can be assigned a plurality of desired states and/or desired actions. Here the user can be provided with information about two subprocesses to be performed successively one after another. A subprocess to be performed next can be for example “removing the (foot) part from the storage area”. The subprocess to be performed next can be assigned a desired action “removing the marked part”. The marked part 462 can be the triangular part 462 marked by means of the marking 722 and arranged in the top left storage area 46, and the marking 722 can be projected by the projector onto the part 462 situated in the storage area on the basis of the information provided by the processor for informing the user 20 about the subprocess to be performed.

A subprocess to be performed after the subprocess “removing the foot part from the storage area” can be “correctly positioning the foot part at the target position”. The subprocess then to be performed can be assigned a desired action “arranging the foot part at the marked target position”. The target position 724 can be projected into the action area by the projector on the basis of the information provided by the processor for informing the user 20.

In various exemplary embodiments, both items of information for the user 20, the marking 722 of the part to be removed and the marking 724 of the target position for the removed part, can be provided simultaneously; by way of example, both markings can be projected into the work area simultaneously, for example since removing the part 462 and arranging the part 462 are two actions that merge into one another.

In various exemplary embodiments, instead of taking the marked triangular part 462, the user 20 can take a rhomboidal part 462 arranged in the right storage area 46. Despite taking the non-marked part 462, the user 20, as illustrated in FIG. 6G, can be provided with a marking 724 of a new target position instead of an error message and/or information concerning a correction subprocess to be performed. The marking 724 of the new target position can be a target position appropriate for the part 462 taken and can be assigned to a subprocess, which can be “correctly positioning the tail part at the target position”. Furthermore, the user can be provided with a text message 484 “Place object at target position”.

One reason for this sequence of the method may be that the subprocess “removing the foot part from the storage area” is assigned not only the desired action “removing the marked foot part” but also a desired action “removing the rhomboidal part”.

If the desired action “removing the marked foot part” is performed, and by means of the detection by the sensor, provision of the detected information to the comparator and communication of the comparison result to the processor, the information illustrated in FIG. 6F is presented to the user by the processor by means of the actuator without a change, i.e. the marking 722 of the triangular foot part which would be arranged after being taken, and so as target position the triangular foot region of the cat would still be indicated as target position 724 (desired state of the subprocess “correctly positioning the foot part at the target position”).

By contrast, if the non-represented desired action “removing the rhomboidal part” is performed, and this is provided for the processor by means of the detection by the sensor, provision of the detected information to the comparator and communication of the comparison result to the processor, the processor provides for the actuator as subsequent subprocess “correctly positioning the tail part at the target position”. In accordance with a desired state assigned to this subsequent subprocess, the actuator would then project as target position the target position 724 illustrated in FIG. 6G for the rhomboidal tail part.

In various exemplary embodiments, as an alternative or in addition to the described representation possibilities for the information with regard to the subprocesses to be performed, other or further possibilities can be used; by way of example, different colors can be used for markings, symbols can be displayed, video sequences for actions to be performed can be represented, for example on a monitor, markings can be animated, e.g. by movement of the marking within the work area, flashing and/or movements at the location (e.g. rotation). Furthermore, the information with regard to the subprocesses to be performed can comprise for example the part 462 to be arranged being passed by means of a robot or the like.

In various exemplary embodiments, a state illustrated in FIG. 6H corresponds to the state—illustrated in FIG. 5D—of the process illustrated in FIG. 5A to FIG. 5D, despite the possibly different assignments of desired states to subprocesses, different degrees of detailing for the information provided for the user 20, etc.

In various exemplary embodiments, quality control can be performed after completion of an object and/or as a concluding subprocess. A result of the quality control can be assigned to the object. The result can be associated with the object, for example stored in the form of a bar code, printed out and applied to the object or a packaging of the object, for example by adhesive bonding.

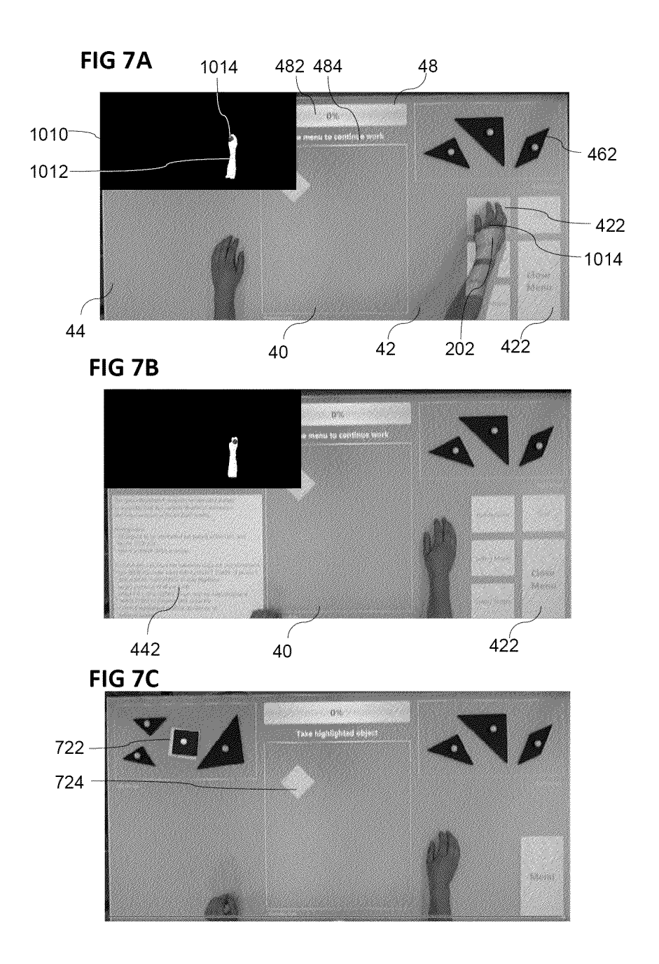

FIG. 7A to FIG. 7C show a work area prior to processing of an object, wherein a method for supporting a process for processing the object in accordance with various exemplary embodiments is performed. In FIG. 7A and in FIG. 7B, depth information images are additionally superimposed as well.

In various exemplary embodiments, the method can be performed by means of a process support system, wherein the process support system can correspond wholly or partly to one or a plurality of the process support systems explained in association with the preceding figures.

In various exemplary embodiments, the process support system can substantially correspond to the process support system explained in association with FIG. 5A to FIG. 5D, and the method for supporting a process for processing the object can substantially correspond to the method explained in association with FIG. 6A to FIG. 6H.

In various exemplary embodiments, a work area illustrated in FIG. 7A to FIG. 7C, similar to the work area illustrated in FIG. 6A, can comprise an action area 40, a menu area 42, two storage areas 46, a first information area 44 and a second information area 48. A plurality of parts 462 can be arranged in the storage areas 46, which parts are to be joined together to form an object within the action area 40. A plurality of virtual menu items 422 can be represented in the menu area 42. A projector (not illustrated) can be used for representing the menu items 422, highlightings, text messages 484, etc.

In various exemplary embodiments, actions, states, etc. can be detected by at least one sensor (not illustrated), for example by a camera.

In various exemplary embodiments, the camera can comprise a 3D camera. The 3D camera can be designed, for example, to obtain three-dimensional information according to the triangulation method described above and to provide it as two-dimensional images, for example coded by intensity values and/or color coded, also designated as depth images. The 3D camera can provide depth images such as, for example, the depth images 1010 illustrated in FIG. 7A and FIG. 7B for example for a comparator (not illustrated).

In various exemplary embodiments, the 3D camera can be designed to provide information about a distance between objects and the 3D camera. The 3D camera can be designed such that it provides distances to objects, for example in the case of a predefined distance of the 3D camera with respect to a reference position. The reference position can be positioned for example on an upper surface of a table.

In various exemplary embodiments, the 3D camera can be used to determine a position of a hand 202 of a user 20 in the work area. The position of the hand 202 can be determined for example within a predetermined area. As is illustrated in FIG. 7A, not only the right hand 202 of the user 20 is situated in the work area (to put it more precisely in the menu area 42), but also the left hand of the user 20 is situated in the work area (to put it more precisely in the first information area 44). However, only the right hand 202 of the user 20 appears white in the depth image 1010. That is to say that only the depth information 1012 detected for the right hand 202 of the user is provided, for example because the depth information for the left hand is filtered out because it is not situated in a currently active area of the work area, or that only the depth information 1012 for the right hand 202 is determined because currently and/or generally non-active areas are not detected by the 3D camera. An active area can be an area in which an action to be detected by the sensor takes place and/or is expected and/or in which a state to be detected is present and/or will be present.

In various exemplary embodiments, the 3D camera can be designed to provide the comparator with the depth image 1010 having the depth information contained therein, including a point 1014 to be evaluated of the hand 202 and, if appropriate, further information preprocessed by the camera. The point 1014 to be evaluated of the hand 202 can be a point of the hand which is evaluated by the comparator for an analysis of a position of the hand 202 in the work area, for example a midpoint of an area covered by the hand 202 in the depth image, a midpoint of a line forming a transition between hand and forearm, a fingertip, for example of an index finger, a highest point of the hand, i.e. a point the furthest away from an upper surface of the table, or more generally of the work area, or the like.

In various exemplary embodiments, the highest point of the hand 202 as point 1014 to be evaluated can be used to define the position of the hand 202 as a projection of the highest point of the hand 202 onto the underlying work surface. The highest point of the hand 202, compared with the midpoint of the area of the hand or of the tip of a finger, shifts only slightly as a result of movements of the hand 202 which do not correspond to a movement of the hand parallel to the work surface, for example rotational movements, curving of the fingers, etc. The highest point of the hand can thus constitute a diversely usable definition for the point 1014 to be evaluated of the hand 202. In various exemplary embodiments, however, other definitions can also be useful. By way of example, the definition of the tip of the index finger as point 1014 to be evaluated can enable for the user a fine control, i.e. a fine positioning, of the point 1014 to be evaluated.

In various exemplary embodiments, the 3D camera can be designed to provide the comparator with only the depth image 1010 having the depth information contained therein, and the comparator can be designed to determine the point 1014 to be evaluated, for example the highest point of the hand 202, and, if appropriate, further required information from the depth image.

In various exemplary embodiments, the 3D camera can be designed to provide the comparator with only raw data, and the comparator can be designed to determine the depth image 1010, the point 1014 to be evaluated of the hand 202 and, if appropriate, further required information.

In various exemplary embodiments illustrated in FIG. 7A to FIG. 7C, the highest point of the hand 202 (the point 1014 to be evaluated) can be provided for the comparator by the 3D camera, or the comparator can determine the highest point of the hand itself from the data provided by the 3D camera.

In various exemplary embodiments, the comparator can be designed to compare the point 1014 to be evaluated of the hand 202 with—provided by the processor—desired actions and/or desired states, and/or desired correction actions and/or desired correction states, which are assigned to the subprocesses and/or correction subprocesses respectively performed.

In various exemplary embodiments, the point 1014 to be evaluated can be defined identically for the entire process, i.e. for all the subprocesses; by way of example, the highest point of the hand can be defined as point to be evaluated for all actions and states for which the position of the hand 202 is determined.

In various exemplary embodiments, the point 1014 to be evaluated can be defined differently for different subprocesses of the process. By way of example, for subprocesses, i.e. for actions and states, for which the position of the hand 202 need only be determined roughly, for example upon the selection of menu items 422 that are relatively large in comparison with the hand, as illustrated in FIG. 7B, the highest point of the hand can be defined as point 1014 to be evaluated. In the case of subprocesses, i.e. in the case of actions and states, for which for example a relatively accurate position has to be determined, for example in the case of a mounting subprocess succeeding the selection on the menu, a definition of the point 1014 to be evaluated as e.g. tip of the index finger can enable a more accurate positioning. In the case of a subprocess for which the highest point of the hand is not directly detectable for example by the 3D camera, for example if an object is arranged in a container by the detected hand, said container being arranged partly between the hand 202 and the 3D camera, for example the midpoint of the line forming the transition between the hand 202 and the forearm can be used as point 1014 to be evaluated, in order that the comparator, on the basis of the position of the point 1014 to be evaluated near an edge of the container, e.g. together with a non-visibility of the hand 202, can deduce that the user 20 has moved the hand 202 to the container.

In various exemplary embodiments, the definition of the point 1014 to be evaluated of the hand 202 can be different for chronologically successive subprocesses. By way of example, firstly a subprocess can be performed in which a virtual menu is operated, and wherein the point 1014 to be evaluated of the hand 202 can be defined as the highest point of the hand 202. After the operation of the menu has ended, the menu may no longer be available and a subprocess can be performed in which a desiccant is introduced into a transport bag by hand, wherein the hand 202 is inserted for the most part into the transport bag, such that for detecting an action of introducing the desiccant into the transport bag, the point 1014 to be evaluated can be defined as the midpoint of the line defining the transition between the hand 202 and the forearm and can be evaluated by the comparator in comparison with a position of the transport bag that is likewise provided by the 3D camera, for example of edges of the transport bag or an area covered by a projection of the transport bag onto the work surface.

In various exemplary embodiments, the definition of the point 1014 to be evaluated of the hand 202 can be different in the case of subprocesses performed spatially in different areas of the work area. By way of example, in the menu area 42 a subprocess can be performed in which a virtual menu is operated, and wherein the point 1014 to be evaluated of the hand 202 can be defined as the highest point of the hand 202. Even after the operation of the menu has ended, the menu may still be available in the menu area 42 (such a state is illustrated by way of example in FIG. 7C). Simultaneously with an availability of the menu, in the action area 40 a subprocess can be performed in which a desiccant is introduced into a transport bag by hand, wherein the hand 202 is inserted for the most part into the transport bag, such that for detecting an action of introducing the desiccant into the transport bag, the point 1014 to be evaluated can be defined as the midpoint of the line defining the transition between the hand 202 and the forearm and can be evaluated by the comparator in comparison with a position of the transport bag that is likewise provided by the 3D camera, for example of edges of the transport bag or an area covered by a projection of the transport bag onto the work surface. To put it another way, that means that the process support system, for example the comparator, can be designed to define different points 1014 to be evaluated of the hand 202 for different areas of the work area, for example for the menu area 42 and the action area 40, and to use said points for the comparison with the desired states and/or desired actions provided by the processor, for example the highest point of the hand 202 in the menu area and the midpoint of the line forming the transition between the hand 202 and the forearm or the tip of the index finger in the action area.

In various exemplary embodiments, as is illustrated in FIG. 7A, the hand 202 of the user 20 can be positioned over a menu item 422 of the plurality of menu items 422. The depth information 1012 of the right hand that is provided for the comparator by means of the 3D camera can be used to determine the highest point of the hand 202 as the point 1014 to be evaluated. A projection of the point to be evaluated onto the work area can be compared by the comparator with desired states provided by the processor for a subprocess “controlling the menu extended by a stage”, i.e. with desired positions which are assigned to the plurality of menu items 422. The desired positions can correspond, for each menu item 422 of the plurality of menu items 422, to an area of the respective menu item that is projected into the menu area by the projector. If the point 1014 to be evaluated, or its projection into the work area, lies within the desired position for a specific menu item 422, the comparator can provide the processor with information that the corresponding desired state is present, and the processor can provide for the actuator the subprocess as subsequent subprocess which is assigned to the subprocess performed when said desired state is present.

In various exemplary embodiments, a time delay can be set up in order to avoid inadvertent or excessively rapid selection of the virtual menu items 422. To put it another way, it may be necessary for the desired state, i.e. in the present example the desired position, to be adopted for a predetermined time. A time duration necessary for the selection of the menu item 422, i.e. for providing the subsequent subprocess, can be presented to the user 20, for example graphically by means of colored filling-in of the projection of the menu item, by means of the introduction of a running clock or hour glass, or the like. In the example illustrated in FIGS. 7A and 7B, the user, for the menu item 422 arranged at the top left in the menu area 422, by means of the positioning of his/her hand 202, or the highest point 1014 of the hand 202, said highest point being marked in the figure, in the part of the work area which is covered by the projection of the menu item 422, for a specific time duration, can bring about display of text information 442 in the first information area 44. To put it another way, in the processor, the subprocess “controlling the menu extended by a stage” having at least the desired states “point to be evaluated in the top left menu item”, “point to be evaluated in the top right menu item”, “point to be evaluated in the middle left menu item”, “point to be evaluated in the bottom left menu item”, “point to be evaluated in the bottom right menu item”, given the presence of the desired state “point to be evaluated in the top left menu item”, is assigned at least the subsequent subprocess “providing the text information in the first information area”. This subsequent subprocess can be provided for the projector by the processor, and the projector can perform the subprocess, wherein the subprocess can be assigned for example the desired action “legibly introducing the desired information at the desired location”.

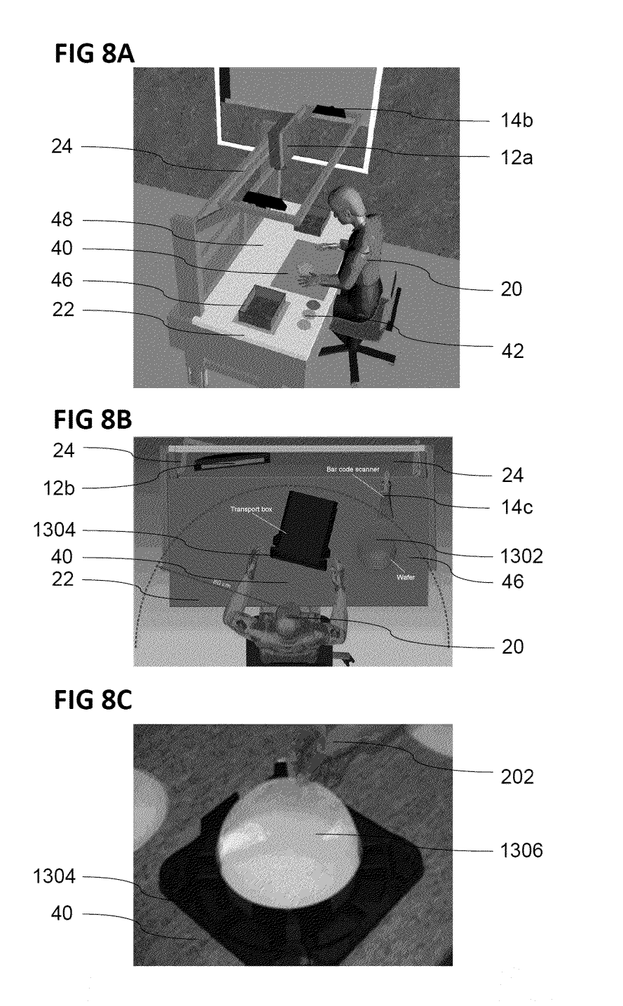

FIG. 8A, FIG. 8B and FIG. 8C show (partial) views of work areas during performance of a process with support by a process support system in accordance with various exemplary embodiments. They provide several examples of how the process support systems can be implemented, and what types of processes can be supported by means of the process support system.

The process support system illustrated in FIG. 8A, unless described otherwise hereinafter, can substantially correspond to a process support system in accordance with the exemplary embodiments described above.

In various exemplary embodiments, the process support system illustrated in FIG. 8A can comprise an actuator 12, for example in the form of a projector 12a, a sensor 14, for example in the form of a 3D camera 14b, a mount 24, on which the 3D camera 14b and the projector 12a can be mounted, and a table 22. The table 22 can provide a work area for performing a process. The process can comprise a plurality of subprocesses. The work area can comprise a plurality of partial areas, for example an action area 40, in which a user 20 can process at least one object, and also a menu area 42 and at least one storage area 46, in which objects can be provided or laid out ready for processing, and an information area 48, in which information about subprocesses to be performed is provided for the user 20. Information about subprocesses to be performed can also be provided for the user in the other areas, for example in the action area 40 and/or in the storage area 46. The information about the subprocesses to be performed can be provided for the user for example by means of the projector 12a, for example by means of projection of information into the work area. The projector can mark for example that storage area 46 from a plurality of storage areas 46 from which a part is to be removed in the next subprocess to be performed, and/or mark a target position for the part in the action area.

In various exemplary embodiments, in the menu area 42 a virtual menu for controlling the process or the subprocess performed can be provided for the user 20, for example in the form of virtual “start”, “pause”, and “stop” switches. By means of arranging his/her hand on a projected area of the respective switch, the user 20 can start, pause and respectively stop a subprocess to be performed, or the information to be provided with respect thereto. The virtual switches can be embodied in a colored fashion, for example green for “start”, yellow for “pause” and red for “stop”.

The process support system illustrated in FIG. 8B, unless described otherwise hereinafter, can substantially correspond to a process support system in accordance with the exemplary embodiments described above.

In various exemplary embodiments, the process support system illustrated in FIG. 8B can comprise an actuator 12, for example in the form of a monitor 12b, a sensor 14, for example in the form of a bar code scanner 14c, at least one mount 24, on which the monitor 12b and the bar code scanner 14c can be mounted, jointly or separately, and a table 22. The table 22 can provide a work area for performing a process, for example the process “packaging a plurality of wafers ready for dispatch”. The process can comprise a plurality of subprocesses. The work area can comprise a plurality of partial areas, for example an action area 40, in which a user 20 can process at least one object, for example a transport box 1304, and also a menu area 42 and at least one storage area 46, in which objects can be provided or laid out ready for processing, for example wafers 1302 for arrangement in the transport box 1304. Information—provided by a processor (not illustrated)—about subprocesses to be performed and/or subprocesses performed, for example information about data read in by means of the bar code scanner 14c and/or about the position at which the wafer 1302 is to be arranged in the transport box 1304, can be provided for the user 20 for example on the monitor 12b. The action area 40, the storage area 46 and a detection region of the bar code scanner 14c can be arranged within reach of the user (illustrated as a semicircular dashed line).

A partial area from FIG. 8B, for example the action area from FIG. 8B, can be illustrated in FIG. 8C. In the process “packaging a plurality of wafers ready for dispatch” which can be performed by means of the process support system illustrated in FIG. 8B, after a subprocess “arranging the first wafer in the transport box”, a subsequent subprocess “arranging a separating film” can be provided for example by the processor (not illustrated). It may be necessary, for example, that a specific desired state is present, for example the information detected by the bar code scanner 14c then corresponds to the desired state, i.e. the desired information, in order that the subsequent subprocess is provided, for example by means of the monitor 12b.

In various exemplary embodiments, the user can arrange the wafer and/or the separating film 1306 by hand 202. The movement of the hand 202 can be detected by a sensor 14, for example by a 3D camera 14b. The movement of the hand 202 that is necessary for arranging the wafer 1302 and/or the separating film 1306 can be such (see FIG. 8C) that a definition of a point to be evaluated of the hand 202 (see FIG. 7A to FIG. 7C and associated description) as the highest point of the hand 202 or as the tip of the index finger appears not to be very useful in this example. Instead, by way of example, a midpoint of the projected area of the hand or the like can be used for defining the point to be evaluated of the hand 202.

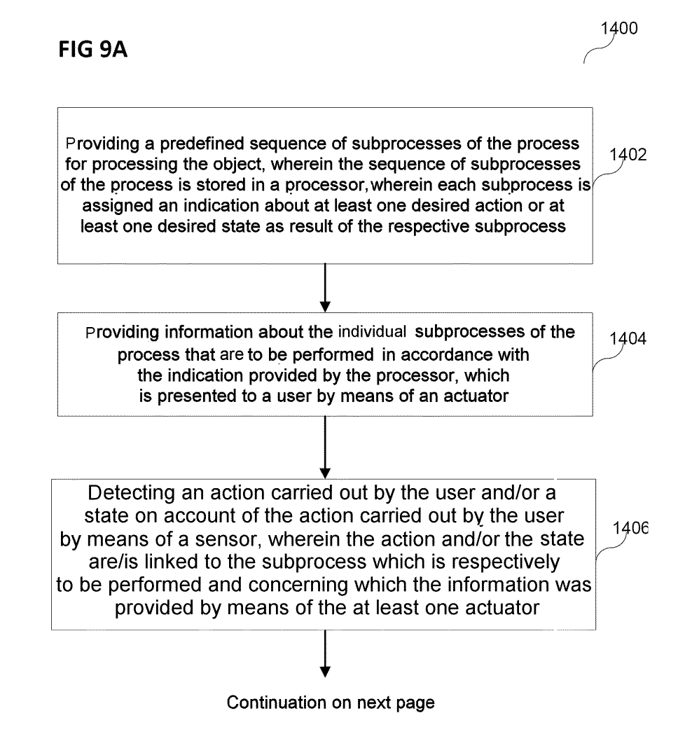

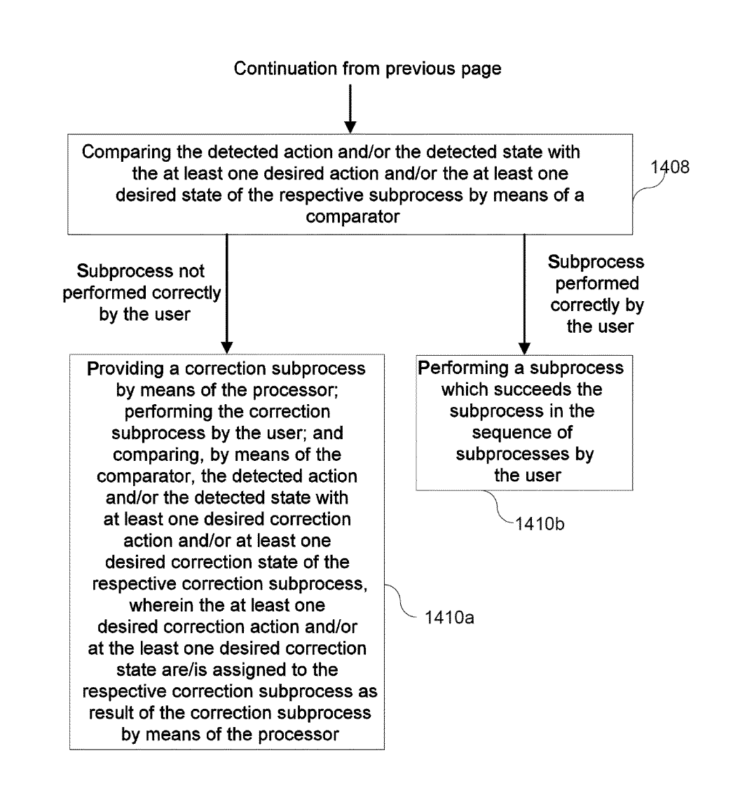

FIG. 9A shows a flow chart illustrating a method 1400 for supporting a process for processing an object in accordance with various exemplary embodiments.

As is illustrated in FIG. 9A, the method 1400 in accordance with various exemplary embodiments can comprise providing a predefined sequence of subprocesses of the process for processing the object (in 1402). The sequence of subprocesses of the process can be stored in a processor, wherein each subprocess can be assigned an indication about at least one desired action or at least one desired state as a result of the respective subprocess.

The method can furthermore comprise providing information about the individual subprocesses of the process that are to be performed in accordance with the indication provided by the processor (in 1404). The information can be presented to a user by means of an actuator.

The method can furthermore comprise detecting an action carried out by the user and/or a state on account of the action carried out by the user by means of a sensor (in 1406). The action and/or the state can be linked to the subprocess which is respectively to be performed and concerning which the information was provided by means of the at least one actuator.

The method can furthermore comprise comparing the detected action and/or the detected state with the at least one desired action and/or the at least one desired state of the respective subprocess by means of a comparator (in 1408).

The method can furthermore comprise providing a correction subprocess by means of the processor, performing the correction subprocess by the user and comparing, by means of the comparator, the detected action and/or the detected state with at least one desired correction state of the respective correction subprocess, wherein the at least one desired correction action and/or the at least one desired correction state are/is assigned to the respective correction subprocess as result of the correction subprocess by means of the processor (in 1410a), for the case where the subprocess was not performed correctly by the user.

The method can furthermore comprise performing a subprocess which succeeds the subprocess in the sequence of subprocesses by the user (in 1410b), for the case where the subprocess was performed correctly by the user.

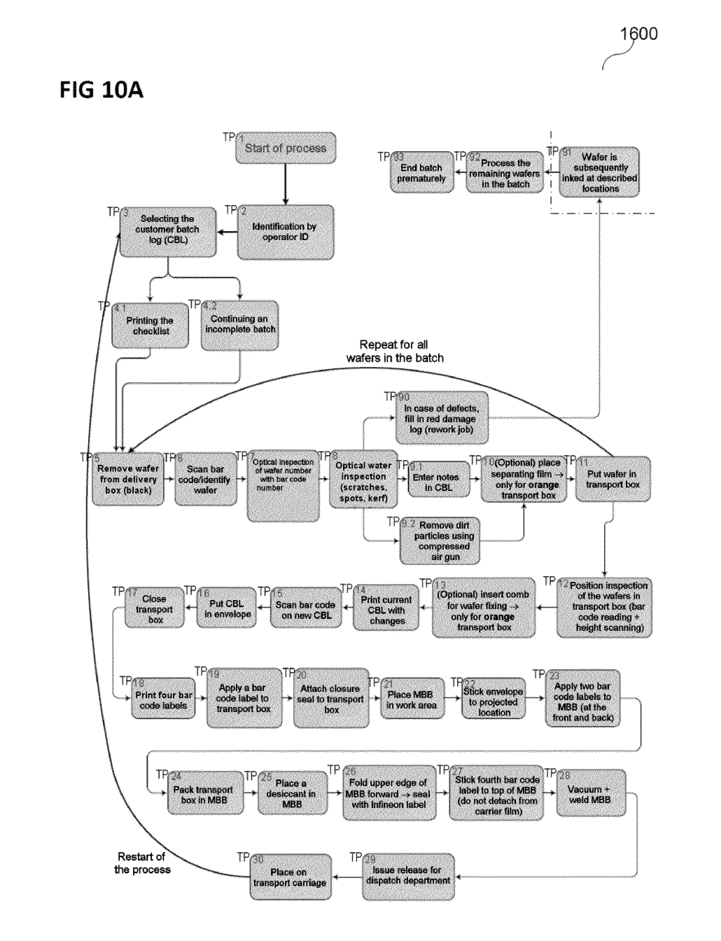

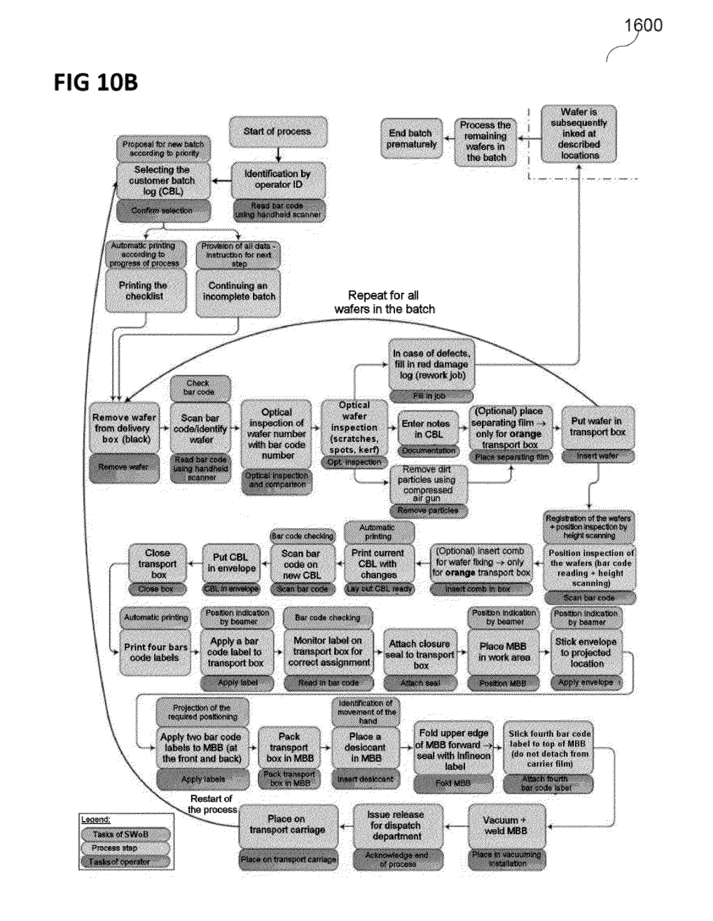

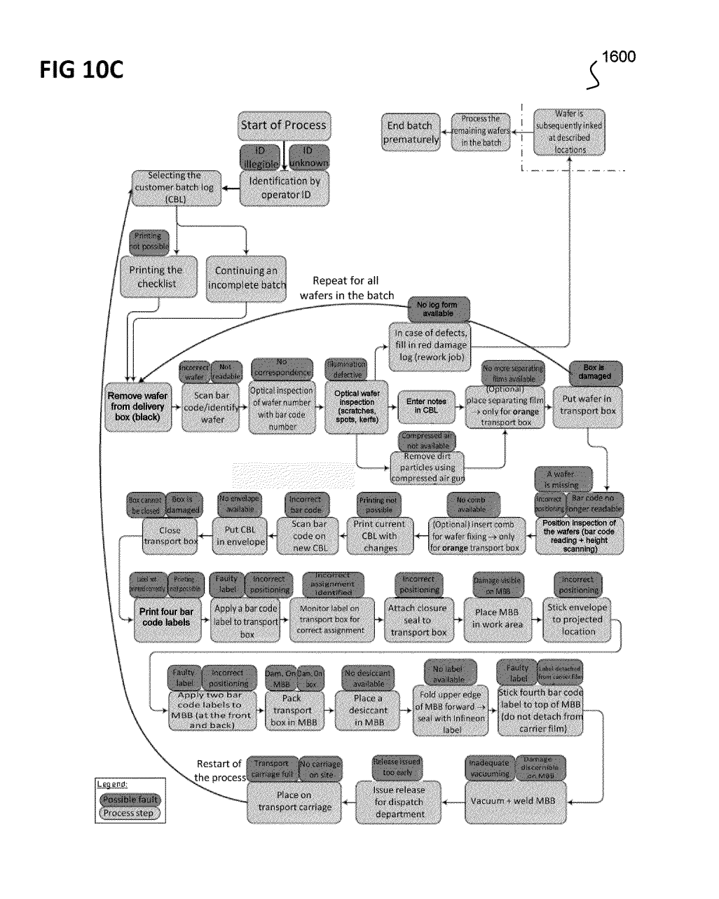

FIG. 10A to FIG. 10C show flow charts of exemplary processes which can be supported by means of a method for supporting a process for processing an object in accordance with various exemplary embodiments and by means of a process support system in accordance with various exemplary embodiments.

In various exemplary embodiments, a process 1600 “packaging a plurality of wafers ready for dispatch” illustrated in FIG. 10A can comprise a plurality of subprocesses TPx (where x stands for a respective numbering of the subprocess that is arranged in a top left corner in FIG. 10A, for example 1 for the subprocess TP1 “start of process”). The plurality of subprocesses TPx can form for example a predefined sequence of subprocesses TPx. The predefined sequence of subprocesses TPx can be stored, for example in a processor. The processor can correspond to one in association with those in exemplary embodiments above for a process support system and/or a method for supporting a process. The processor can be designed to provide a user with the subprocesses TPx or the predefined sequence of subprocesses TPx. The processor can provide the user with, for example, in each case the next subprocess(es) TPx to be performed, for example by means of an actuator, for example by means of a projector.

In various exemplary embodiments, the predefined sequence of subprocesses TPx illustrated in FIG. 10A can be a substantially undisturbed sequence of subprocesses which is provided for the user by the processor. The user can be provided with, for example, in each case the next subprocess to be performed by means of the actuator, for example by means of the projector, for example by means of a text message. The text message can provide for example the text indicated in the boxes for the respective subprocess TPx, for example “printing the checklist” for TP4.1, for the user, for example by means of a projection into a work area.

In various exemplary embodiments, by means of a sensor, for example by means of a camera and/or by means of a bar code scanner, it is possible to detect what action was carried out during/after provision of a subprocess TPx to be performed and/or what state was attained. The sensor can provide a comparator with what has been detected. By means of a comparison of what has been detected by the sensor, that is to say for example the action detected by the sensor and/or the state detected by the sensor, with at least one desired action provided by the processor and/or a desired state provided by the sensor, the comparator can determine whether or not the respective subprocess TPx was carried out successfully.

By way of example, in the case of subprocess TP6, the user can scan a bar code of a wafer which the user removed from a delivery box during subprocess 5, by means of the bar code scanner. The bar code scanner can provide the comparator with the result of the scan. The comparator can compare the result of the bar code scan provided by the bar code scanner with a bar code which is provided by the processor and which is intended to be present for wafers to be arranged in a transport box present (desired state, in this case desired bar code). The comparator can provide the processor with the result of the comparison. If the result of the comparison is that the bar code corresponds to at least one desired bar code, the processor can provide for the user the subsequent subprocess TP7 in the represented sequence of subprocesses TPx, for example in the form of a text message having the content of the box from TP7 in FIG. 10A “optical inspection of wafer number with bar code number”. A case where the bar code detected by the bar code scanner does not correspond to at least one of the desired bar codes is not illustrated in FIG. 10A. In that case, the processor can provide the user with an assigned correction subprocess.

In various exemplary embodiments, a branching of the process 1600 that is illustrated after subprocess TP8 can comprise subprocesses TP90, TP9.1 and TP9.2 which are assigned to the subprocess TP8 as subsequent subprocesses. The fact of whether the processor provides the user with the subprocess TP90, TP9.1 or TP9.2 as subprocess to be performed can be dependent on whether conditions are met which can be stored in the processor and can be assigned to the respective subprocesses TP90, TP9.1 and TP9.2. The fact of whether at least one of the conditions is met can be provided for the processor by the comparator, for which the conditions can be provided by the processor. In the present example, an optical wafer inspection in TP8, which the user can perform for example by means of his/her eyes and provide for a sensor, for example a (virtual) menu, can detect one of a plurality of states, for example a production defect in the wafer, a defect-free wafer, or a contaminated wafer. The comparator can compare the states provided by the sensor, for example the menu operated by the user, with the conditions assigned to the assigned subsequent subprocesses and can provide the processor with the result. In the case where the production defect is present in the wafer, the processor can provide the user with the subprocess TP90 (“in case of defects, fill in red damage log (rework job)”) to which this condition is assigned. In the case of a defect-free wafer, the processor can provide the user with the subprocess TP9.1 (“enter note in CBL”) to which this condition is assigned. In the case of a contaminated wafer, the processor can provide the user with the subprocess TP9.2 (“remove dirt particles using compressed air gun”) to which this condition is assigned.

In various exemplary embodiments, only the defect-free wafer can be the desired state assigned to TP8, and the subprocess TP9.1 can be the subsequent subprocess assigned to TP8. A contaminated wafer or a defective wafer can constitute states deviating from the desired state, such that the processor provides the user with the correction subprocess assigned to the subprocess TP8. Conditions for providing the respective correction subprocesses can correspond to the conditions described above for providing the subprocesses TP90 and TP9.2, and the assigned correction subprocesses can correspond to the subprocesses TP90 and TP9.2 defined there as subprocesses.

FIG. 10B illustrates the process 1600 from FIG. 10A. The subprocesses (no longer numbered here) correspond to those illustrated in FIG. 10A.

In comparison with FIG. 10A, FIG. 10B at least partly provides supplementation concerning for what subprocess TPx the process support system can become or be active, and in what form (text above the box—also illustrated in FIG. 10A—with the designation of the respective subprocess), and for what subprocess TPx the user can become or be active, if appropriate.

In various exemplary embodiments, for subprocess TP5 “remove wafer from delivery box (black)”, for example, the user can perform an action “remove wafer”. The removal of the wafer can be the desired action assigned to TP5.

In various exemplary embodiments, for example in the case of a low degree of detailing, as early as before, during or after the removal of the wafer, the user can be provided with the subsequent subprocess TP6 “scan bar code/identify wafer”.

In various exemplary embodiments, for example in the case of a high degree of detailing, the subsequent subprocess TP6 can be provided if the comparator provides the processor with the fact that the desired action “remove wafer” was performed successfully. For assessing whether the desired action was performed, a sensor, for example a camera, can provide the comparator with information about the action performed by the user (not illustrated in FIG. 10B), and the comparator can compare the information provided by the sensor with the desired action provided by the processor and can provide the processor with the result of the comparison. If the result of the comparison is that the desired action was performed, i.e. the wafer was removed successfully, the processor can provide the user with the subsequent subprocess TP6, for example by means of displaying a text message.

FIG. 10C illustrates the process 1600 from FIG. 10A and FIG. 10B. The subprocesses (no longer numbered here) correspond to those illustrated in FIG. 10A.

In comparison with FIG. 10A, FIG. 10C at least partly provides supplementation concerning what fault can occur for what subprocess TPx. The possible faults formulated as text above the box—also illustrated in FIG. 10A—with the designation of the respective subprocess can represent states and/or actions which do not correspond to the desired states and/or desired actions assigned to respective subprocesses TPx. They can form conditions which are assigned to a correction subprocess assigned to the subprocess. In the case where the condition is present (which the comparator determines on the basis of the information provided by the sensor and provides for the processor), the user can be provided with the corresponding correction subprocess. The correction subprocess can be displayed as a text message, for example.

The process illustrated in FIG. 10A to FIG. 10C is merely one example of a type of processes for which a method for supporting a process for processing an object is applicable and/or a process support system can be applied. The process support system and/or the method described can be applied for any other manual or partly manual process in which an action carried out is detectable by a sensor and/or in which the user can be provided with information about the subprocesses to be performed.

A further example of a process for which the process support system can be applied is identifying defective components in an array of components. The user can detect defective components, for example by means of a test circuit. The test circuit can be the at least one sensor of the process support system and can provide the comparator with the result of the test. The comparator can compare the result from the test circuit with the arrangement of components, in each case defect-free as desired state, which arrangement is provided by the processor. The comparator can provide the processor with positions of defective components, for example, as result of the comparison. The processor can indicate the positions of the defective components to the user as information about the correction subprocess to be performed, such that the user knows which components he/she ought to remove. The sensor (for example the test circuit) can be used to detect whether a desired correction state (defective component removed) assigned to the correction subprocess was attained.

In various exemplary embodiments, a process support system for processing an object can be provided. The process support system can comprise a processor. The processor can be designed for providing a predefined sequence of subprocesses of a process for processing an object. The sequence of subprocesses of the process can be stored, wherein each subprocess is assigned an indication about at least one desired action, or at least one desired state as result of the respective subprocess. The process support system can furthermore comprise at least one actuator for providing information, which is presented to a user, about the individual subprocesses of the process that are to be performed in accordance with the indication provided by the processor. The process support system can furthermore comprise at least one sensor for detecting an action carried out by the user and/or a state on account of the action carried out by the user. The action and/or the state can be linked to the subprocess which is respectively to be performed and concerning which the information was provided by means of the at least one actuator. The process support system can furthermore comprise a comparator, designed for comparing the detected action or the detected state with the at least one desired action and/or the at least one desired state of the respective subprocess. The processor can be designed in such a way that, for the case where the comparison reveals that the subprocess was not performed correctly by the user, said processor provides a correction subprocess, which is performed by the user, and, for the case where the comparison reveals that the subprocess was performed correctly by the user, said processor provides a subprocess which succeeds the subprocess in the sequence of subprocesses and which is performed by the user. The processor can furthermore be designed to assign to the correction subprocess an indication about at least one desired correction action and/or at least one desired correction state as result of the correction subprocess. The comparator can be designed to compare the detected action and/or the detected state with the at least one desired correction action and/or the at least one desired correction state of the respective correction subprocess.

In one configuration, the processor can be designed in such a way that, for the case where the comparison of the detected action and/or of the detected state with the at least one desired correction action and/or the at least one desired correction state reveals that the correction subprocess was performed correctly by the user, said processor provides the subprocess which succeeds the subprocess in the sequence of subprocesses and which is performed by the user.

In one configuration, the information about the individual subprocesses to be performed, which is presented to the user, can contain advice as to how the desired action is to be performed.

In one configuration, the information about the individual subprocesses to be performed, which is presented to the user, can contain advice as to how the desired state is to be brought about.

In one configuration, an abundance of detail in the advice can be adaptable.

In one configuration, the abundance of detail in the advice can be adaptable to the user's experience.

In one configuration, the process support system can furthermore comprise a work area in which the sequence of subprocesses of the process is to be carried out.

In one configuration, the action carried out by the user and/or the state on account of the action carried out by the user can comprise a gesture made by the user.

In various exemplary embodiments, a method for supporting a process for processing an object is provided. The method can comprise providing a predefined sequence of subprocesses of the process for processing the object, wherein the sequence of subprocesses of the process can be stored in a processor, wherein each subprocess can be assigned an indication about at least one desired action or at least one desired state as a result of the respective subprocess. The method can furthermore comprise providing information about the subprocess of the process that is to be performed in accordance with the indication which is provided by the processor and which is presented to a user by means of an actuator. The method can furthermore comprise detecting an action carried out by the user and/or a state on account of the action carried out by the user by means of a sensor, wherein the action and/or the state can be linked to the subprocess which is respectively to be performed and concerning which the information was provided by means of the at least one actuator. The method can furthermore comprise comparing the detected action and/or the detected state with the at least one desired action and/or the at least one desired state of the respective subprocess by means of a comparator. The method can furthermore comprise performing one alternative from a first alternative and a second alternative. The first alternative can be performed in the case where the comparison reveals that the subprocess was not performed correctly by the user. The first alternative can comprise providing a correction subprocess by means of the processor, and performing the correction subprocess by the user and comparing, by means of the comparator, the detected action and/or the detected state with at least one desired correction action and/or at least one desired correction state of the respective correction subprocess, wherein the at least one desired correction action and/or the at least one desired correction state can be assigned to the respective correction subprocess as a result of the correction subprocess by means of the processor. The second alternative can be performed in the case where the comparison reveals that the subprocess was performed correctly by the user. The second alternative can comprise performing a subprocess which succeeds the subprocess in the sequence of subprocesses by the user.

In one configuration, the method can furthermore comprise confirming the carrying out of a subprocess by the user.

In one configuration, the method can furthermore comprise confirming the carrying out of a subprocess by the user.

In one configuration, the method can furthermore comprise assigning at least one result of the at least one comparison to the object.

In one configuration, assigning the at least one result can comprise coding the at least one result in an object marking.

In one configuration, the method can furthermore comprise attaching the object marking, wherein the object marking is unambiguously assignable to the object on the basis of an attachment position.

In one configuration, the object marking can comprise a bar code label and/or an RFID transponder.

In one configuration, the method can furthermore comprise reproducing information detected by the sensor by means of the actuator.

Further advantageous configurations of the method are evident from the descriptions of the process support system, and vice versa.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A process support system for processing an object, the process support system comprising:
a processor, designed for providing a predefined sequence of subprocesses of a process for processing an object, wherein the sequence of subprocesses of the process is stored, wherein each subprocess is assigned an indication about at least one desired action or at least one desired state as result of the respective subprocess;
at least one actuator for providing information, which is presented to a user, about the individual subprocesses of the process that are to be performed in accordance with the indication provided by the processor;
at least one sensor for detecting an action carried out by the user and/or a state on account of the action carried out by the user, wherein the action and/or the state are/is linked to the subprocess which is respectively to be performed and concerning which the information was provided by means of the at least one actuator; and
a comparator, designed for comparing the detected action or the detected state with the at least one desired action and/or the at least one desired state of the respective subprocess;
wherein the processor is designed in such a way that, for the case where the comparison reveals that the subprocess was not performed correctly by the user, said processor provides a correction subprocess, which is performed by the user, and, for the case where the comparison reveals that the subprocess was performed correctly by the user, said processor provides a subprocess which succeeds the subprocess in the sequence of subprocesses and which is performed by the user; and
wherein the processor is furthermore designed to assign to the correction subprocess an indication about at least one desired correction action and/or at least one desired correction state as result of the correction subprocess, and wherein the comparator is designed to compare the detected action and/or the detected state with the at least one desired correction action and/or the at least one desired correction state of the respective correction subprocess.

2. The process support system as claimed in claim 1,
wherein the processor is designed in such a way that, for the case where the comparison of the detected action and/or of the detected state with the at least one desired correction action and/or the at least one desired correction state reveals that the correction subprocess was performed correctly by the user, said processor provides the subprocess which succeeds the subprocess in the sequence of subprocesses and which is performed by the user.

3. The process support system as claimed in claim 1,
wherein the information about the individual subprocesses to be performed, which is presented to the user, contains advice as to how the desired action is to be performed.

4. The process support system as claimed in claim 1,
wherein the information about the individual subprocesses to be performed, which is presented to the user, contains advice as to how the desired state is to be brought about.

5. The process support system as claimed in claim 3,
wherein an abundance of detail in the advice is adaptable.

6. The process support system as claimed in claim 5,
wherein the abundance of detail in the advice is adaptable to the user's experience.

7. The process support system as claimed in claim 1, further comprising:
a work area in which the sequence of subprocesses of the process is to be carried out.

8. The process support system as claimed in claim 1,
wherein the action carried out by the user and/or the state on account of the action carried out by the user comprises a gesture made by the user.

9. A method for supporting a process for processing an object, comprising:
providing a predefined sequence of subprocesses of the process for processing the object, wherein the sequence of subprocesses of the process is stored in a processor, wherein each subprocess is assigned an indication about at least one desired action or at least one desired state as result of the respective subprocess;
providing information about the subprocess of the process that is to be performed in accordance with the indication provided by the processor, which is presented to a user by means of an actuator;
detecting an action carried out by the user and/or a state on account of the action carried out by the user by means of a sensor, wherein the action and/or the state are/is linked to the subprocess which is respectively to be performed and concerning which the information was provided by means of the at least one actuator;
comparing the detected action or the detected state with the at least one desired action and/or at the least one desired state of the respective subprocess by means of a comparator; and
performing one of the alternatives:
in the case where the comparator reveals that the subprocess was not performed correctly by the user:
providing a correction subprocess by means of the processor;
performing the correction subprocess by the user; and
comparing, by means of the comparator, the detected action and/or the detected state with at least one desired correction action and/or at least one desired correction state of the respective correction subprocess, wherein the at least one desired correction action and/or the at least one desired correction state are/is assigned to the respective correction subprocess as result of the correction subprocess by means of the processor; or
in the case where the comparison reveals that the subprocess was performed correctly by the user:
performing a subprocess which succeeds the subprocess in the sequence of subprocesses by the user.

10. The method as claimed in claim 9, further comprising:
confirming the carrying out of a subprocess by the user.

11. The method as claimed in claim 9, further comprising:
confirming the carrying out of a subprocess by the user.

12. The method as claimed in claim 9, further comprising:
assigning at least one result of the at least one comparison to the object.

13. The method as claimed in claim 12,
wherein assigning the at least one result comprises coding the at least one result in an object marking.

14. The method as claimed in claim 13, further comprising:
attaching the object marking, wherein the object marking is unambiguously assignable to the object on the basis of an attachment position.

15. The method as claimed in claim 13,
wherein the object marking comprises a bar code label and/or an RFID transponder.

16. The method as claimed in claim 9,
further comprising:
reproducing information detected by the sensor by means of the actuator.
